(19) United States
(12) Patent Application Publication
(10) Pub. No.: US 2025/0375922 A1
(43) Pub. Date: Dec. 11, 2025

(54) PROACTIVE AI-DRIVEN CONCRETE-PRODUCTION SYSTEM WITH PROTECTED SENSOR ASSEMBLY FOR CONCRETE MIXERS

(71) Applicant: Sensolyzer Advanced Sensing Systems Ltd., Herzliya (IL)

(72) Inventor: Yaniv KNOP, Herzliya (IL)

(21) Appl. No.: 19/311,488

(22) Filed: Aug. 27, 2025

Related U.S. Application Data
(63) Continuation-in-part of application No. 18/939,807, filed on Nov. 7, 2024.
Application No. 18/939,807 is a continuation-in-part of application No. 18/514,023, filed on Nov. 20, 2023.
Application No. 18/514,023 is a continuation-in-part of application No. PCT/IL2022/050173, filed on Feb. 14, 2022.
(60) Provisional application No. 63/192,693, filed on May 25, 2021.

(51) Int. Cl. B28C 7/02; B08B 3/02; B28C 7/16; B60P 3/16; G05B 13/02

(52) U.S. Cl. CPC B28C 7/024; B08B 3/02; B28C 7/161; B60P 3/16; G05B 13/0265

(57) ABSTRACT

A system and method for controlling concrete production are disclosed. The system includes a protected, self-cleaning sensor assembly positioned at an entrance of a concrete mixer tank. The assembly comprises a robust housing with a protective upper cover to deflect materials, a transparent front cover for a sensor array including at least a camera, and an active cleaning system with water and air nozzles. This assembly provides continuous, real-time sensor data (visual, acoustic, thermal) to a proactive artificial intelligence (AI)-based control system. The AI system processes this data to autonomously determine the type, quantity, and timing of chemical admixture additions to maintain desired concrete properties. The AI system is also configured to control the assembly's cleaning system in a coordinated wash-and-dry sequence, ensuring the integrity and reliability of the incoming sensor data for closed-loop control of the concrete production process.

### CROSS REFERENCE TO RELATED APPLICATIONS

This application is a Continuation-in-Part of U.S. patent application Ser. No. 18/939,807, filed Nov. 7, 2024, which is a Continuation-in-part of U.S. patent application Ser. No. 18/514,023, filed Nov. 20, 2023, which is a Continuation-in-part of PCT Patent Application No. PCT/IL2022/050173 having International filing date of Feb. 14, 2022, which claims the benefit of priority of U.S. Provisional Patent Application No. 63/192,693, filed May 25, 2021, the contents of which are all incorporated herein by reference in their entirety.

### TECHNICAL FIELD

The present invention relates generally to the field of monitoring systems for industrial mixing equipment. More specifically, the invention pertains to sensor assemblies for use in concrete mixers, such as those on stationary plants or mobile trucks. In particular, the invention is directed to a protected, self-cleaning sensor assembly designed for robust installation and continuous operation within the hostile, abrasive, and fouling environment of a concrete mixing drum.

### BACKGROUND

Concrete is the most widely used construction material around the world. It is a composite material with a complex structure composed of water, fine aggregates, coarse aggregates, sand, chemical additives, and various chemical admixtures bonded together with a fluid cement (cement paste) that hardens (cures) over time. Cement normally comprises from 10 to 15 percent of the concrete mix, by weight. Through a process called hydration reaction, the cement and water react, harden, and bind the aggregates into a rock-like mass. This setting and hardening process continues from when cement is mixed with water and may continue for several months, meaning concrete gets harder over time. Portland cement is not a brand name, but the generic term for the type of cement used in virtually all concrete, just as stainless is a type of steel and sterling a type of silver. Therefore, there is no such thing as a cement sidewalk, or a cement mixer; the proper terms are concrete sidewalk and concrete mixer.

Cement paste is produced by a rapid process of hydration of clinker minerals, releasing large amounts of heat once the cement is mixed with water over a period of minutes, hours and days. Tricalcium silicate (C₃S) is one of the main cementitious components of Portland cement, and its hydration reaction is represented by the following chemical equation:

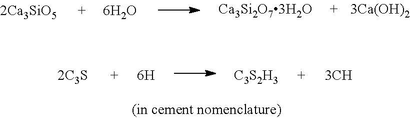

The products formed by the slow hydration reaction over several weeks are calcium silicate hydrate, known as C—S—H, and calcium hydroxide. Dicalcium silicate (C₂S) hydrates much more slowly than C₃S does, to form similar type of C—S—H and Ca(OH)₂:

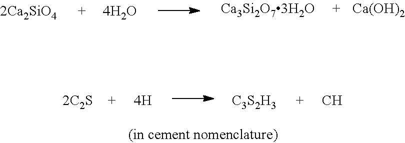

Tricalcium aluminate (C₃A) hydrates very quickly, within minutes to hours, generating large amounts of heat, to form C₂AH₈ and C₄AH₁₃, which then convert with time to stable C₃AH₆:

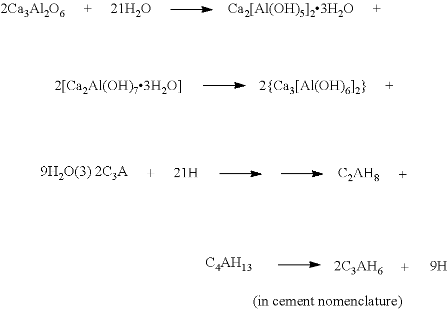

A rapid reaction immediately follows between the calcium sulphate in solution and the calcium aluminate hydrate, lasting from several minutes to hours, releasing large amounts of heat and forming ettringite:

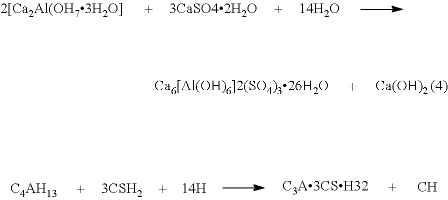

Another, fourth, component of cement is calcium aluminoferrite (C₄AF), and its hydration is very similar to that of C₃A. Mortar is prepared by adding sand to the cement and water mix, according to known preparation methods. Concrete is prepared by adding sand and aggregates (gravel) to the cement mix with water as well as different chemical additives and different chemical admixtures according to the desired properties. The last two ingredients, C₃A and C₄AF undergo an immediate reaction in the first minutes after adding the water together with the plaster. This reaction significantly affects the properties and survivability of the chemical additives.

Cement clinker is a solid material produced to production Portland cement as an intermediary product. Clinker occurs as lumps or nodules, usually 3 to 25 millimetres in diameter. It is produced by sintering (fusing together without melting to the point of liquefaction) limestone and aluminosilicate materials such as clay during the cement kiln stage.

Concrete is a fascinating material with a complex structure. At the macroscopic level, it appears as a simple two-phase composite: aggregate particles embedded within a cement paste matrix. However, zooming in reveals a third, crucial phase: the interfacial transition zone (ITZ) between the aggregate and the hardened cement paste (HCP). This microscopic realm, particularly the intricate pore system within the HCP, has become a focal point of concrete research in recent decades.

The pore system, characterized by its porosity and pore size distribution, significantly influences the strength and durability of concrete. Various methods exist to analyse these characteristics, including fluid displacement, helium psychometry, capillary condensation, adsorption-desorption isotherms, small-angle X-ray scattering (SAXS), scanning electron microscopy (SEM), nuclear magnetic resonance (NMR), AC impedance spectroscopy, mercury intrusion porosimeter (MIP), and backscattered electron imaging (BSE).

Pores come in various types and shapes, each playing a specific role. Gel pores, capillary pores, compaction pores, and ITZ pores all contribute to the overall pore volume, affecting properties like shear rate, strength, workability, and consistency of the concrete mix. Durability, however, is primarily governed by the interconnectedness of these pores. Larger pores exert a greater influence on strength and durability than gel pores, which mainly affect shrinkage and creep. Understanding the porosity and pore size distribution provides valuable insights into the overall performance of concrete. These characteristics are influenced by factors such as the water-to-cement ratio, age, and size of the cement particles.

Beyond porosity, other parameters also impact the workability and consistency of fresh concrete. These include the flow behaviour within the mixer, segregation and bleeding tendencies, homogeneity, continuity, fluidity, colour, air contact, degree of hydration, and heat of hydration rate. Continuous monitoring of these parameters is essential during concrete production.

Today, fresh concrete is typically produced in stationary concrete plants. These plants create concrete mixes with a specific slump (or flow) level and consistency, which are essential for workability. The concrete is then transported to construction sites in mixer trucks. However, several chemical and physical processes can occur during production, transportation, and even while waiting to discharge the concrete. These processes can negatively affect the concrete, primarily by reducing its slump and consistency. Several factors contribute to this, including:
Environmental factors: Fluctuations in ambient temperature and humidity.
Cement hydration: The chemical reaction between cement and water, which starts during mixing.
Cement composition: Different cement components react at varying rates.
Admixtures: Chemical admixtures can have unpredictable effects on the concrete properties, and these effects can be influenced by environmental conditions and interactions with other concrete components.
Aggregate condition: Water absorption and increased moisture content in the aggregates.
Contamination: The presence of clays, dust, or other impurities.
Raw material variability: Changes in the quality of raw materials like aggregates, cement, and admixtures.
Human error: Mistakes made by operators during the production process.
Time: The time elapsed from initial production to the final unloading of concrete at the construction site.

These undesirable processes alter the properties of the fresh concrete mix, impacting its performance, hardening ability, and other key characteristics. To counteract these effects, it's often necessary to add water at the construction site, along with higher doses of chemical admixtures like retarders and water reducers. In some cases, additional cement or admixtures might be added as a safety measure. However, these adjustments can lead to further issues, such as producing unstable concrete mixes and compromising the final concrete quality.

The use of such subpar concrete mixes, which deviate from the desired specifications, can have detrimental effects on construction projects. Uncontrolled addition of water further aggravates the problem, adversely affecting both the performance characteristics of fresh and hardened concrete and the instability of fresh and hardened concrete. To prevent this, quality control is essential. This involves ensuring the concrete mix consistently meets the required specifications and that the final product possesses the desired properties, including strength, durability, workability, and appearance. Achieving this requires thorough testing and monitoring at various stages of the production and construction process. The quality of concrete is paramount in any construction project, as it directly influences the structure's durability, load-bearing capacity, and resistance to environmental factors.

To address these challenges, volumetric stationary concrete mixers and volumetric concrete production trucks have been introduced. These systems offer several advantages over traditional ready-mix concrete plants and trucks. A volumetric stationary concrete mixer is a highly mechanised and automated piece of equipment designed for precise concrete production. Fixed in a permanent location, it accurately weighs and mixes cement, aggregates, and water according to a specified ratio, ensuring consistent concrete quality. In contrast, a ready-mix concrete mixer involves a more complex setup. It utilises a system of storage, feeding, batching, mixing, and control devices to combine various aggregates, binders, admixtures, additives, and water in precise proportions. This centralised mixing process supplies large quantities of fresh concrete. A central control room, equipped with a computerised control system, manages and monitors the entire production process, from handling raw materials to discharging the finished concrete mix.

A ready-mix truck is equipped with a large rotating drum that transports the pre-mixed concrete from the stationary plant to the construction site. The concrete is typically batched and mixed at the plant and continues to mix during transport. Conversely, a volumetric concrete production truck allows for continuous production of concrete even during transport. This on-site mixing capability enables adjustments to the concrete mix based on factors like delivery time, environmental conditions, changes in raw material quality, and any chemical reactions or physical changes that occur during transit. Unlike a ready-mix truck, a volumetric truck has separate compartments for various chemical admixtures and water. After calibration, the truck's onboard computer can calculate the precise amount of each ingredient needed to produce any type of concrete mix with the desired properties, flow, strength, and setting time, ensuring consistent quality despite the challenges of transportation.

Essentially, large volume stationary concrete mixers and production trucks provide the advantage of producing and delivering fresh concrete on demand, as well as maintaining concrete stability throughout the entire time from production to unloading of concrete at the construction site. This eliminates the issue of the concrete becoming “hot” or prematurely setting in the drum during transport, which can necessitate the addition of water and lead to uncontrolled changes in the concrete's properties. However, even with the advantages of volumetric mixers, certain challenges persist. The concrete delivered by these trucks often arrives with either too much or too little water, resulting in a mix that is too “wet” or too “dry”. This inconsistency stems from inaccuracies in the batching system, variations in the raw materials or admixtures, inconsistencies in the timing of admixtures addition, or fluctuations in environmental conditions during production and transport. Consequently, the delivered concrete may not meet the required specifications, necessitating adjustments at the construction site. potentially compromising the concrete's quality, and adversely affecting its intended performance.

The present invention describes a proactive, Al-driven system for controlling the properties of concrete during production and transport by autonomously adding chemical admixtures. It solves these long-standing problems in the concrete:
1) Inconsistent Concrete Quality During Production and Transportation: Concrete properties can change significantly during production and transit due to factors like hydration, temperature variations, and aggregate absorption or infections such as the presence of clay. This often leads to inconsistent quality upon arrival at the construction site, requiring rework or compromising the final product. The invention's real-time monitoring and AI-driven admixture control directly address this issue, ensuring concrete properties remain within desired specifications throughout transportation.
2) Uncontrolled Water Addition at Construction Sites: To compensate for slump loss during transit, workers often add water at the construction site, negatively impacting concrete strength and durability. The invention minimizes the need for such water additions, preserving concrete quality and structural integrity.
3) Overuse of Chemical Admixtures: Traditional concrete production often involves adding excess admixtures at the concrete plant to compensate for potential slump losses, resulting in increased costs and environmental problems or instability due to uncontrolled material addition. The invention optimizes admixture usage by making precise additions based on real-time needs, reducing waste and promoting sustainability.
4) Lack of Real-Time Quality Control: Current quality control methods often involve periodic sampling and testing, which may not detect issues that arise during transportation. The invention's continuous monitoring and AI analysis enable proactive identification and correction of quality deviations before the concrete is placed.
5) Manual Intervention and Human Error: Relying on manual adjustments and human judgment to maintain concrete quality is prone to inconsistencies and errors. The invention's autonomous control system eliminates the need for manual intervention, ensuring consistent and optimized admixture additions.
6) Inefficient Use of Lower-Quality Aggregates: Using lower-quality aggregates can lead to challenges in achieving desired concrete properties. The invention's ability to tailor admixture additions in real-time could enable the effective use of a wider range of aggregates, potentially reducing costs and promoting resource efficiency.

Thus, by optimising admixture usage and minimizing cement content (through improved quality control), the present invention contributes to reducing the carbon footprint of concrete production and reducing the environmental impact, in general. Moreover, consistent concrete quality and reduced rework can improve construction productivity and project timelines. Also, the system's continuous data collection can provide valuable data-driven insights into concrete behaviour, enabling further optimization of mix designs and production processes. The successful operation of such an advanced control system is predicated on the availability of continuous and accurate real-time data from within the concrete mixer itself.

However, while various systems have been proposed for monitoring concrete properties, a fundamental and unsolved technical challenge remains: the inability to deploy sensitive optical and electronic sensors directly within the active mixing environment. The interior of a concrete mixer tank is exceptionally hostile. During loading and mixing, the sensors are subjected to high-impact abrasion from coarse aggregates, fouling from cementitious paste, and obstruction by dust and slurry.

Any conventional camera or sensor placed within the mixer's opening would be rendered inoperable within seconds, either by being covered in concrete or physically damaged. This has prevented the acquisition of reliable, real-time visual and other sensor data from within the mixer. Consequently, the industry has relied on indirect measurements (e.g., hydraulic pressure) or manual, intermittent checks, which fail to capture the dynamic changes occurring within the mix.

There is therefore a critical need for a system that can physically protect a sensor suite, maintain a clear optical path for a camera, and operate reliably for extended periods within the harsh environment of a concrete mixer tank. The present invention addresses this long-standing need by providing a novel, protected, and self-cleaning sensor assembly specifically engineered for this purpose, thereby enabling the practical implementation of advanced concrete control systems.

### SUMMARY

The present invention provides a protected and self-cleaning sensor assembly for a concrete mixer. In one aspect of the present invention, a monitoring system assembly (100) for a concrete mixer is provided. The assembly comprises a housing configured for positioning at an entrance of a concrete mixer tank, with the housing containing a sensor array that includes a camera (104) and a light source (105) to illuminate an area visible to the camera. The housing further comprises a protective upper cover (111) shaped to deflect a flow of concrete materials, a transparent front cover (110) providing a sealed window for the camera, and an active cleaning system with at least one water nozzle (101) to direct a fluid spray across the transparent cover's external surface.

In another embodiment, the protective upper cover (111) has a curved profile substantially continuous with a surface of a raw material feeding chute where the housing is mounted, which minimizes direct impact from flowing materials. In still another embodiment, the active cleaning system further comprises an air-nozzle to direct a jet of air across the external surface of the transparent front cover (110).

In a further embodiment, the water nozzle (101) and the air-nozzle are configured to operate in a coordinated sequence to first wash and then dry the transparent front cover (110). In yet another embodiment, the housing is mounted on an adjustable mechanism that enables vertical and horizontal position adjustment to optimize the camera's line of sight. In a certain embodiment, the sensor array also includes a microphone/acoustic sensor (103) and a temperature sensor (102) enclosed within the housing.

In a particular embodiment, the transparent front cover (110) is made of an abrasion-resistant material such as hardened glass or polycarbonate. In another embodiment, the housing is configured for installation on a raw material feeding chute of the concrete mixer. In still another embodiment, the protective upper cover (111) serves as a primary defence by deflecting material flow, while the active cleaning system serves as a secondary defence by removing adhered slurry and dust.

In another aspect of the present invention, a concrete mixer truck is provided, comprising a concrete mixer tank with a raw material feeding chute and the monitoring system assembly (100) according to any of the preceding embodiments mounted on the feeding chute.

In yet another aspect of the present invention, a concrete production system is provided. The system comprises a concrete mixer tank and a plurality of chemical admixture reservoirs; a proactive artificial intelligence (AI)-based control system configured to receive real-time sensor data and autonomously control a dispensing mechanism to dispense admixtures into the mixer tank; and a continuous monitoring system assembly of the present invention, configured to provide said real-time sensor data to the proactive AI-based control system.

In an embodiment of the system, the sensor array of the monitoring system assembly further comprises a microphone/acoustic sensor (103) and a temperature sensor (102), and the AI-based control system is configured to receive and process visual, acoustic, and temperature data. In another embodiment, the active cleaning system of the monitoring system assembly further comprises an air-nozzle, and the AI-based control system is further configured to operate the water nozzle (101) and the air-nozzle in a coordinated sequence to wash and then dry the transparent front cover (110). In a further embodiment, the housing of the monitoring system assembly is mounted on an adjustable mechanism enabling its position to be optimized for improved data collection.

In a final aspect of the present invention, a method for controlling the production of concrete is provided. The method comprises: continuously monitoring one or more properties of concrete within a mixer tank using the monitoring system assembly of the present invention; receiving, at a proactive AI-based control system, real-time sensor data from the sensor array of said monitoring system assembly; autonomously determining, by the proactive AI-based control system, an action required to maintain the one or more properties of the concrete within a desired range; and controlling a dispensing mechanism to execute the determined action.

In an embodiment of the method, the real-time sensor data comprises at least visual data from the camera (104), acoustic data from a microphone/acoustic sensor (103), and temperature data from a temperature sensor (102). In another embodiment, the method further comprises activating the active cleaning system to direct a fluid spray from the water nozzle (101) to maintain an unobstructed line of sight for the camera (104). In a further embodiment, the step of activating the active cleaning system is triggered by the AI-based control system and comprises operating the water nozzle (101) and an air-nozzle in a coordinated wash-and-dry sequence to first wash and subsequently dry the transparent front cover (110).

Various embodiments may allow various benefits and may be used in conjunction with various applications. The details of one or more embodiments are set forth in the accompanying figures and the description below. Other features, objects and advantages of the described techniques will be apparent from the description and drawings and from the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Disclosed embodiments will be understood and appreciated more fully from the following detailed description taken in conjunction with the appended figures. The drawings included and described herein are schematic and are not limiting the scope of the disclosure. It is also noted that in the drawings, the size of some elements may be exaggerated and, therefore, not drawn to scale for illustrative purposes. The dimensions and the relative dimensions do not necessarily correspond to actual reductions to the practice of the disclosure.

FIG. 1 schematically shows the system of the present invention and the result of its operation, which is building a set of instructions on adding certain different chemical admixtures at specific amounts and at particular intervals of time into the mixer tank for the driver, the external operator, or the autonomous operating system.

FIG. 2 shows an image of a slump test of concrete.

FIG. 3 shows images of the low-slump (dry) concrete discharged at the construction site and having a much lower slump level than required.

FIG. 4 shows an image of concrete provided with a suitable slump after water was added to the concrete directly at the construction site.

FIG. 5 shows, on the left, three types of different concrete mixed in a concrete mixer, and, on the right, three corresponding images of the slump level of the concrete as tested.

FIG. 6 shows concrete that has not been mixed enough and therefore lumps can be seen in the concrete.

FIG. 7 shows an image of decomposed concrete having a collapsed slump and a lot of water bleeding and concrete segregation.

FIG. 8 shows an image of shows an image of an incorrect grading of aggregates in the concrete having a high slump and, therefore a concrete mixture with segregation.

FIG. 9 shows the segregation of the hardened concrete in the wall, in one of the newly built structures.

FIG. 10 schematically shows the concrete production process of the present invention.

FIGS. 11A-11C show the monitoring system assembly (100) for a concrete mixer of the present invention from various angles.

FIG. 12 shows the enlarged perspective view of the monitoring system assembly (100) of the present invention.

FIG. 13 shows the potential placement of the monitoring system assembly (100) as a part of the concrete production system of the present invention.

FIGS. 14A and 14B are images of the inside of a concrete mixer taken by the camera of the system of the invention.

FIG. 15 shows the sum of average water added (gallons/yard³) for each system in both hot and cool conditions.

FIG. 16 shows the sum of average slump (inches) for each system with dry and wet aggregates.

FIGS. 17A, 17C, 17E, 17G, 171, 17K, 17M and 170 show the images of the ready-mix concrete or precast concrete having different grades, which indicate different physical properties (consistency, segregation, and homogeneity) and different workability (slump or flow level) of the concrete.

FIGS. 17B, 17D, 17F, 17H, 17J, 17L, 17N and 17P show the corresponding images processed in the computing unit for each and every grade using the filter that identifies the shade contours of the images using the image pixels hue levels. That gives an indication of the levels of consistency and homogeneity (fluidity) and slump of the concrete by correlating these measured levels to the level of consistency, homogeneity and slump determined by the relevant standard.

FIG. 18 shows an example of the sound intensity measurement with an acoustic sensor during the mixing of the concrete.

FIG. 19A shows a thermogram made with a thermal imaging camera of an inhomogeneous concrete mix in the mixer tank and water separation of the concrete.

FIG. 19B shows a thermogram made with a thermal imaging camera of concrete during its mixing in the mixer tank.

FIGS. 20A-20C show the results of the experiment in Example 6 on hydration stabilisation of the concrete hydration process. FIG. 20A shows a gradual increase in concrete temperature over time. FIG. 20B shows the slump (mm) of the produced concrete over time maintained around 100 mm with adjustments. FIG. 20C shows the setting time of the produced concrete, gradually adjusted and maintained close to 4 hours.

FIG. 21 shows the results of the experiment in Example 7 on adjusting the slump (workability) of the produced concrete over time.

### DETAILED DESCRIPTION

In the following description, various aspects of the present application will be described. For purposes of explanation, specific details are set forth to provide a thorough understanding of the present application. However, it will also be apparent to one skilled in the art that the present application may be practiced without the specific details presented herein. Furthermore, well-known features may be omitted or simplified in order not to obscure the present application.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps, or components as referred to, but does not preclude the presence or addition of one or more other features, integers, steps or components, or groups thereof. Thus, the scope of the expression “a device or system comprising x and z” should not be limited to devices or systems consisting only of components x and z. Also, the scope of the expression “a method comprising the steps x and z” should not be limited to methods consisting only of these steps.

Unless otherwise clear from context, all terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

In the following detailed description, non-limiting embodiments of the present invention are discussed and illustrated, where references are made to accompanying drawings. These embodiments and accompanying drawings should be understood as non-limiting examples of implementing the present invention. Furthermore, terms such as “optionally”, “e.g.,”, “may”, etc., refer to optional features being selected in certain embodiments of the invention for the sake of simplicity and clear explanation. It should be understood, however, that optional features mentioned in different embodiments may be used, in conjunction and/or separately, to carry out further embodiments of the present invention.

The present invention provides a system and method for reliable, real-time monitoring of concrete within a mixer by solving the critical challenge of protecting sensors and maintaining their operational integrity in a hostile environment. The core of the invention is a physical assembly designed to survive and function within the harsh, abrasive, and fouling conditions inside a concrete mixer tank. Non-limiting embodiments of the present invention are discussed and illustrated, where references are made to the accompanying drawings.

The system of the present invention is capable of autonomously controlling the addition of admixtures based on real-time monitoring and AI decision-making. It continuously monitors in real time concrete properties during the concrete production and transportation, enabling timely adjustments. The system of the present invention is entirely AI-driven, based on machine learning models, and it drives the decision-making process for admixture addition.

The system of the present invention aims to maintain concrete quality by primarily adjusting admixtures and essentially minimising the addition of water. The AI model suitable for the autonomous admixture control system in the concrete production mixer is a hybrid model combining reinforcement learning (RL) and supervised learning. Its core components are:

### (1) Reinforcement Learning (RL) Agent

The RL agent's goal is to learn the optimal policy for adding admixtures and water, maximising concrete quality while minimising water usage. Its state encompasses real-time sensor data (temperature, slump, etc.), concrete mix design parameters, environmental conditions, and time elapsed since mixing. The action space consists of decisions on the type, quantity, and timing of admixture/water addition. The reward function reflects the concrete's quality, penalising deviations from desired properties and excessive water usage. It incorporates factors like compressive strength, workability, setting time, and cost efficiency.

### (2) Supervised Learning (SL) Model

The SL model's objective is to predict concrete properties based on sensor data, admixture history, and other relevant factors. This model aids the RL agent in decision-making. Historical data from concrete production, including sensor readings, admixture additions, and resulting concrete properties is used as training data. The model type is a regression model (e.g., neural network, random forest) to predict continuous properties like slump or compressive strength, or a classification model for discrete properties like setting time categories.

The AI workflow of the present invention comprises the following stages:
(i) Data Collection: Gather extensive data from concrete production processes, including sensor readings, admixture additions, environmental factors, and concrete quality outcomes.
(ii) Supervised Learning Model Training: Train the supervised learning model to predict concrete properties based on the collected data.
(iii) RL Agent Training:
   The RL agent interacts with the concrete production environment (simulated or real).
   It receives sensor data and uses the supervised learning model to predict concrete property evolution.
   It takes actions (admixture/water addition) and receives rewards based on concrete quality and resource efficiency.
   The RL agent learns the optimal policy through trial and error, guided by the reward function.
(iv) Deployment: The trained RL agent is deployed on the mobile concrete production system. It continuously monitors concrete properties, makes admixture/water addition decisions in real-time, and adapts its policy based on new data.

The hybrid AI model of the present invention is highly adaptable. The RL agent allows the system to learn and adapt to varying conditions and concrete mix designs. It is also highly predictable. The SL model helps the RL agent anticipate concrete property changes, enabling proactive admixture adjustments. In addition, the RL is capable of optimizing admixture usage for cost-effectiveness and environmental friendliness. Also, the AI hybrid model of the present invention allows for real-time decision-making during concrete transportation. A realistic simulation environment can be valuable for initial RL agent training and testing, reducing risks in real-world deployment. Techniques like attention mechanisms or model-agnostic explanations provide insights into the AI's decision-making, increasing trust and facilitating troubleshooting. Special safeguards are implemented in the AI hybrid model of the invention to prevent the AI from making decisions that could compromise concrete quality or safety.

In some embodiments, the reinforcement learning agent uses the predictions from the supervised learning model to make the determination. In other embodiments, the AI-based control system is configured to determine a quantity of admixtures and water to add to the concrete based on the data received from the continuous monitoring system.

In a further embodiment, the proactive AI-based control system of the invention comprises:
A reinforcement learning agent configured to learn an optimal policy for adding the admixture based on the data received from the continuous monitoring system; and
A supervised learning model configured to predict temporal changes in the one or more properties of the concrete during the transporting based on historical concrete production data.

In some embodiments, the proactive AI-based control system uses machine learning models to predict admixture addition requirements. In another embodiment, the reinforcement learning agent uses the predictions from the supervised learning model to make the autonomous determination. In a certain embodiment, the method of the present invention further comprises autonomously determining a quantity of water to add to the concrete based on the data received from the continuous monitoring system.

The embodiments of the present invention describe the real-time monitoring and control during the concrete production and transportation, whereas the above acknowledged prior art focuses on initial mix optimisation or monitoring at the batch mixer. The embodiments explicitly state the use of a continuous monitoring system with a specific combination of sensors, whereas the above acknowledged prior art mentions sensors in general but do not specify the combination or how the data is used. The proactive AI-based control system's ability to autonomously determine admixture type, quantity, and timing clearly distinguishes the present invention from systems that rely on user input or simple historical data analysis. Moreover, the present invention prioritises minimizing water addition, whereas the above acknowledged prior art is silent about water reduction during the concrete production and transportation.

By definition, proactive AI is an artificial intelligence system that anticipates and fulfils the needs of users without prompting. This type of AI uses the latest algorithms, machine learning (ML), and predictive analytics to forecast future commands and proactively respond to them. Reactive AI operates in the moment. It analyses incoming data, compares it to its knowledge base, and then reacts accordingly. It can be thought as a reflex action. It does not predict or anticipate future events; it simply responds to the current situation. In contrast, proactive AI, on the other hand, anticipates future needs and events. It leverages historical data, predictive models, and real-time information to make decisions and take action before an event occurs. This allows it to optimise processes, prevent problems, and capitalise on opportunities. Reactive AI focuses on reacting to current situations, whereas proactive AI anticipates and prevents future events. Reactive AI uses primarily current data and makes decisions based on immediate context, whereas proactive AI uses historical, real-time, and predictive data and makes decisions based on predictions and long-term goals. Thus, reactive AI only responds to events, whereas proactive AI initiates actions.

For example, a sensor controlled by reactive AI can only detect a specific parameter, compare it to a predefined threshold, and then trigger an alert for the concrete production system operator. In contrast, the proactive AI of the present invention analyses historical sensor data, creates system performance logs, considers external factors like weather and temperature, and uses this information to predict when concrete quality is likely to decline. It then proactively schedules the autonomous addition of a specific admixture to the concrete mixer, determining both the amount and timing of the addition.

In one embodiment of the present invention, the concrete production platform is a stationary platform operated by an external operator or an autonomous operating system. In another embodiment, the concrete production platform is a mobile platform operated by a driver, an external operator, or an autonomous operating system for transporting components of the system. In some embodiments, the dispensing mechanism comprises dispensers, flow meters, and nozzles for controlled and continuous measuring, dosing, and dispensing of the admixtures and water into the mixer tank as directed by the AI-based control system.

In another embodiment, said continuous monitoring system comprises at least two sensors selected from the group consisting of an imaging camera, a hydraulic pressure gauge, a temperature gauge, and an acoustic sensor.

In a further embodiment, said imaging camera, for example a thermal image camera, is installed inside the concrete mixer tank for continuously gathering visual information, thermal information, and thermal profile of the concrete at any time during production, before transportation, during transportation, prior to discharge and during the discharge of the concrete through a mixer trough at a construction site.

The acoustic senor is installed on the mixer tank for continuously examining changes in a sound level (dB), frequency (Hz) and duration, and a sound of low and full load of the concrete inside the concrete mixer, said acoustic senor is thus configured to monitor the workability, cohesion, homogeneity, segregation, and water separation of the concrete.

The hydraulic pressure gauge is installed for indicating a hydraulic pressure of the concrete inside the concrete mixer tank and a hydraulic load intensity on the mixer motor during loading and prior to discharge of the concrete while mixing at a high rotation frequency of the mixer tank from about 5 rpm to about 95 rpm, and during transportation while mixing at a low rotation frequency from about 1 rpm to about 4 rpm. The hydraulic pressure and hydraulic load intensity are indicators of the workability of the prepared concrete, and said hydraulic pressure gauge is thus configured to provide an indication to simulate the workability of the concrete.

The temperature gauge is installed for continuously monitoring and controlling the concrete temperature and surrounding temperature outside the mixed concrete, said at least one temperature gauge is thus configured to monitor a hydration progress, including the degree of hydration, rate of heat of hydration and slump or flow reduction of the concrete, and water absorption by aggregates of the concrete.

After preloading aggregates, including sand, gravel, and crushed stone rock, to the stationary mixer or the truck mixer tank in the concrete plant, chemical additives, for example, fly ash or slag, water, and a chemical clinker (including gypsum addition) used as a binder (cement) for producing concrete upon mixing with water, the required chemical admixtures are disposed in the corresponding reservoirs on the concrete production platform.

The chemical admixtures are proactively added to the mixer at a certain rate, at different times during the production and transportation process, and the dosages are controlled by the AI-based system developed in accordance with the present invention, depending on the properties of the raw materials in the concrete, the progress of the chemical reaction of the cement with water, and chemical and physical changes that occur during the transport of the concrete to and from the construction site.

The autonomously controlled and continuous addition of the particular types of the chemical admixtures, in specific dosages, and at particular intervals of time is one of the major aspects of the present invention. In fact, such addition of the chemical admixtures in the proactively controlled and continuous manner obviates the use of water in the production of the concrete in stationary mixers or on the go and make the entire concrete production process much more efficient and allows the full automation of the production process.

Furthermore, the mobile platform does not need to transport large volumes of water, in contrast to a conventional concrete mixing truck. Carefully controlled and continuous addition of the chemical admixtures without water makes it possible to prepare the fresh concrete or batched concrete mix and maintain the required and desired physicochemical properties of the concrete, its stability, quality, and homogeneity during the transportation and then during the discharge of the prepared concrete at the construction site. In the present invention, only small amounts of water are added from a small water container installed on the mobile platform to wash the residuals of the dispensed dosage of a chemical admixture into the mixing tank, thereby increasing accuracy of the dosing and dispensing of the chemical admixtures.

Thus, the concrete production process of the present invention is fully controlled and adjusted by an “autonomous operating system”, which is a proactive AI-based control system of the present invention that enables the fully autonomous operations for an unmanned stationary or mobile platform and continuous monitoring and quality control. The AI-based system of the invention make the decisions in accordance with the properties of the raw materials, such as aggregate water absorption rate, aggregate moisture, quality of the aggregates and sand, presence of impurities, such as dust or clay, in the raw materials, hydration rate, transportation time, hydration progress of the different cement component and fineness of the cement, external temperature and humidity conditions, and the desired physicochemical properties of the obtained concrete.

The following physicochemical parameters of the produced concrete and of the concrete production process are continuously monitored by the concrete-monitoring and quality-control system, and adjusted, if needed:
a slump level or flow (workability) reduction of the concrete computed from a slump simulation and continuous changes in the slump level with time;
an amount and type of a chemical admixture to be added to the concrete in the mixer tank in accordance with the desired properties of the prepared and mixed concrete and the properties of aggregates and cement used for the production of the concrete, in order to maintain or adjust to a required level the desired workability, setting times, homogeneity and other performances of the concrete without addition of water;
a bonding time with the cement;
an initial and final setting times of the concrete;
a rate profile (delay or acceleration) for the addition of an admixture in order to maintain or adjust to a required level of the desired concrete strength or desired setting times;
an air content of the concrete in the mixer tank;
a degree of hydration of the concrete to a predetermined level computed from the visual information, thermal information, and thermal profile of said concrete and computed as a fraction of a chemical clinker that has fully reacted with water during the binding process. The degree of hydration is adjusted to the predetermined level by the addition of a hydration stabiliser (retarder) or acceleration agent of the concrete;
a fineness of the produced cement and other concrete components upon mixing with water affecting a rate of heat evolution of the cement in the concrete and viscosity of the concrete, said heat evolution is proportional to a change in the concrete viscosity during the concrete production process, and said parameters are used to compute a dosage amount, a number of dosages, a time interval between the dosages and a rate of addition of a hydration stabiliser and an increased slump admixture into the mixer tank; and
a homogeneity and consistency of the concrete including presence of the aggregates in the concrete, density and concrete colour, height, size, shape, and colour of the aggregates inside the concrete, water bleeding, and segregation of the concrete.

In general, the rate of heat of hydration of cement in the concrete indicates the viscosity of the concrete and determines an amount of a hydration stabiliser to be added to the cement in the mixer tank. The hydration stabiliser is one of the chemical admixtures formulated to retard the concrete production over extended periods of time or on the other hand, to add accelerator admixture to decrease the setting time and also to prevent the freeze of water in cold areas to achieve faster setting and increased an initial strength. The heat of hydration of cement is heat evolution, which is proportional to the change in viscosity during the concrete production process.

In certain embodiments of the present invention, the above physicochemical parameters of the produced concrete are correlated with an amount of water to add to the concrete in the concrete mixer tank in order to reach a required water-to-cement ratio and not to exceed this ratio. The physicochemical parameters of the produced concrete are also correlated with an amount and types of the different chemical admixtures to add to the produced concrete at predetermined dosages and intervals of times, to disperse said concrete and thereby increase the slump level of the concrete to the desired slump level, without adding water.

Reference is now made to Table 1 that provides a framework for the AI model's operation of the present invention. The implementation of this framework involves complex algorithms and decision-making processes. However, this illustrates the core aspect of using combined sensor data and proactive AI to autonomously control admixture addition in real-time during the concrete production and transportation.

TABLE 1
Al-Driven Admixture Control in Mobile Concrete Production.

| Specific | | | | |
|---|---|---|---|---|
| Parameter of | Change in | Sensor(s) | | |
| Concrete | Parameter | Reacting | Signal Received | Admixture/Water Action |
| Slump | Decrease | Imaging camera, | Change in concrete flow | Dispersant admixture (e.g., |
| Workability | below desired | hydraulic | pattern, decrease in | polycarboxylate) in calculated |
| | level | pressure gauge | hydraulic pressure | dosage |
| Slump | Increase | Imaging camera, | Change in concrete flow | No action or potential |
| Workability | above desired | hydraulic | pattern, Increase in | retarder if setting time is also |
| | level | pressure gauge | hydraulic pressure | affected |
| Temperature | Increase | Temperature | Rise in concrete | Retarder admixture to slow |
| | above desired | gauge | temperature | hydration |
| | range | | | |
| Temperature | Decrease | Temperature | Drop in concrete | Accelerator admixture to |
| | below desired | gauge | temperature | speed up hydration, or |
| | range | | | potential heating if feasible |
| Setting Time | Slower than | Acoustic sensor, | Change in acoustic | Accelerator admixture |
| | desired | potentially slump | signature as concrete | |
| | | test | stiffens, reduced slump | |
| Setting Time | Faster than | Acoustic sensor, | Change in acoustic | Retarder admixture |
| | desired | potentially slump | signature as concrete | |
| | | test | stiffens rapidly, | |
| | | | Reduced slump | |
| Air Content | Below desired | Acoustic sensor | Change in acoustic | Air-entraining admixture |
| | level | (indirectly), | signature, low air | |
| | | potentially air | content reading | |
| | | content test | | |
| Air Content | Above desired | Acoustic sensor | Change in acoustic | No action or potential |
| | level | (indirectly), | signature, high air | adjustment of mix design in |
| | | potentially air | content reading | future batches |
| | | content test | | |
| Segregation/ | Visual | Imaging camera | Change in concrete | Viscosity modifying |
| Bleeding | evidence of | | appearance, visible | admixture (e.g., VMA) or |
| | separation | | separation of | potential adjustment of mix |
| | | | aggregates or water | design in future batches |
| Aggregate | Change | Moisture sensor | Variation in moisture | Adjust initial water addition |
| Moisture | detected | (at loading point) | content reading | or consider aggregate source |
| | during initial | | | change |
| | loading | | | |

In this table, while the primary focus is on real-time, non-destructive sensing, the slump test and ait content test can be incorporated periodically for calibration or validation. Specific admixture dosages are determined by the AI model based on the magnitude of the parameter change, concrete mix design, and other relevant factors. The proactive AI model continuously learns and refines its decision-making based on the outcomes of its actions and any additional data collected. In addition, the proactive AI system implements safeguards to prevent the AI from taking actions that could compromise concrete quality or safety. Human oversight or intervention may be necessary in certain situations.

In one embodiment of the present invention, the AI input sensor data comprises images or video frames of the concrete in the mixer tank from an imaging camera; real-time hydraulic pressure readings from a hydraulic pressure gauge; concrete and ambient temperature measurements from a temperature gauge; sound level, frequency, and duration data from an acoustic sensor; optionally an aggregate moisture content at loading from a moisture sensor; and optionally a mixer tank rotation speed from and RPM gauge. In another embodiment of the present invention, the AI input contextual data comprises target slump, strength and setting time from (concrete mix design); aggregate properties including type, size distribution and moisture content; cement type including hydration characteristics, environmental conditions, such as temperature and humidity; time elapsed since initial mixing; and admixture history including admixture types and quantities already added.

A historical data fed to the AI system may be the following parameters selected from:
a type of concrete,
an amount of the water added before the transportation, during the transportation, prior to the discharge and during the discharge of the concrete,
an amount of cement added,
a maximum water-to-cement ratio allowed according to the type of the concrete,
types and technical characteristics of the different chemical admixtures,
a grading and types of the aggregates and their mix,
loading times of the materials used for the production of the concrete before the transportation, during the transportation, prior to the discharge and during the discharge of the concrete,
a required workability (slump/flow level) of the produced concrete,
a required air percentage content data, and an intended concrete application means.

In a further embodiment of the present invention, the AI output comprises decisions on type of admixture to add (if any), quantity of admixture to add, timing of admixture addition, and quantity of water to add (if any). In addition, the AI of the invention may also output the levels of and deviations from the desired quality and stability of the produced concrete in the concrete mixer tank during the transportation and prior to the discharge, are characterised by one or more parameters:
quality, consistency, workability, and stability of the concrete being produced in the mixer tank during the transportation and prior to the discharge;
a computed volume of the concrete in the concrete mixer tank computed from an estimated volume discharged by a number of discharge rounds of the tank and by a number of empty blade spiral revolutions;
a concrete temperature and the surrounding temperature;
sound changes that indicate drying and homogeneity of the concrete; and
deviations from physicochemical parameters of the concrete production process.

In yet further embodiment of the present invention, the proactive AI comprises at least one of the following deep layers:
(1) Convolutional Neural Networks (CNNs) for Image Analysis:
   Process image data from the imaging camera.
   Extract features like concrete flow patterns, segregation, and bleeding.
   CNNs are adept at recognising visual patterns and can learn to associate them with concrete properties.
(2) Recurrent Neural Networks (RNNs) or Transformers for Time-Series Data:
   Handle sequential sensor data (temperature, pressure, sound) over time.
   Capture temporal dependencies and trends in concrete property evolution.
   RNNs (especially LSTMs) or Transformers are well-suited for modelling time-series data.
(3) Multi-Layer Perceptrons (MLPs) for Feature Integration:
   Combine and process features from CNNs, RNNs, and other sensor data.
   Learn complex relationships between various input features and concrete properties.
   MLPs are versatile for integrating and transforming data from multiple sources.
(4) Reinforcement Learning (RL) Network:
   Receives integrated features and contextual data as input.
   Outputs the decision on admixture/water addition.
   The RL network learns the optimal policy through trial and error, guided by the reward function that reflects concrete quality and resource efficiency.

In the present invention, these layers work together as follows. Sensor data processing is realised through CNNs processing images and RNNs/Transformers handling time-series sensor data. Feature extraction and integration is performed with MLPs combining and transforming features from different sensors and models. The RL network uses the integrated features and contextual data to make admixture/water addition decisions. The outcomes of the AI's actions (concrete quality, resource usage) are fed back as rewards to the RL agent, enabling it to learn and improve its policy over time (feedback loop).

Pre-training CNNs on large image datasets and RNNs/Transformers on relevant time-series data significantly improves the overall performance. If data is limited, transfer learning from related domains (e.g., material science) can help initialise the models. In order to understand the AI's decision-making process, techniques like attention mechanisms or model-agnostic explanations can be incorporated. Safeguards are implemented to prevent unsafe or undesirable actions. In addition, the AI model of the present invention is robust to noisy or incomplete sensor data.

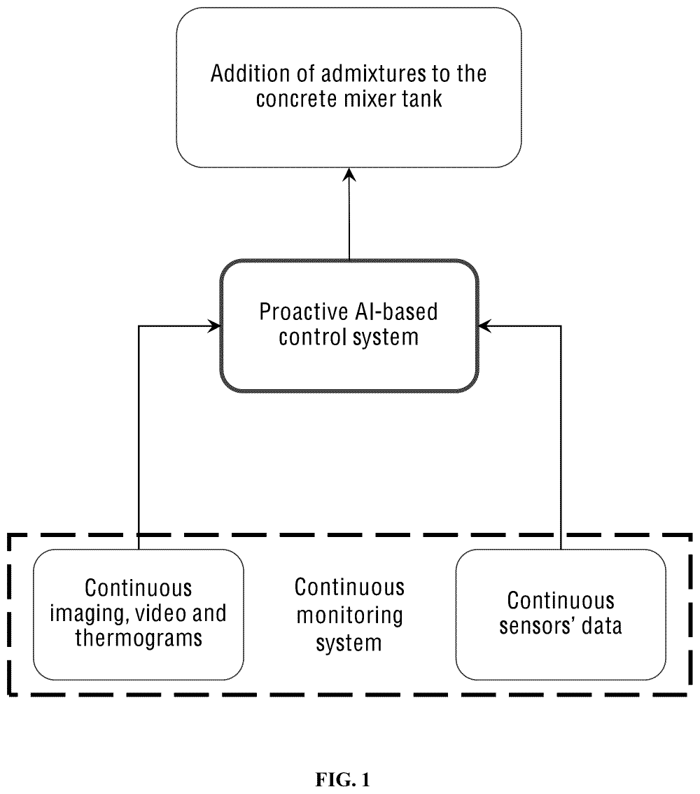

The monitoring and adjusting process is continuous, which means it is automatically carried out by the AI-based system of the present invention until the concrete is discharged (offloaded) or prior to that, if so desired. Reference is now made to FIG. 1 schematically showing the system of the present invention and the result of its operation, which is autonomously adding certain chemical admixtures at specific amounts and at particular intervals of time into the concrete mixer tank and minimising addition of water to the concrete while maintaining the one or more properties of the concrete within the desired range.

In the present application, the term “volumetric concrete production” means the production of concrete, which is mixed and delivered to the construction site by volume of concrete, rather than weight. Volumetric concrete in the present invention is autonomously produced from various ingredients (water, cement, additives as fly ash, slag, limestone powders etc., sand, and aggregates) in self-contained portable batch mixers, which produce concrete by proportioning the materials out over time by volume and relating that volume back to the materials specific weight. Volumetric concrete production offers complete control over when, where, how much, and what type of concrete is mixed and applied for any type of project, large or small. That flexibility to adapt to any situation is unmatched by any other approach.

The term “fresh concrete” means that the concrete had been recently mixed from the beginning of loading the concrete in the plant, transporting the concrete, discharging the concrete, and completing the application of the concrete on the concrete element. It has the required homogeneity and consistency, and it possess its original workability at any time and state before transportation, during transportation, prior to discharge and during the discharge of the concrete through a mixer trough at a construction site, so that it can be placed, handled, consolidated, and finished by the intended methods. Concrete is referred to as “fresh” when the setting and hardening process has not yet started. “Fresh concrete” can be deformed and poured which means it can be transported or pumped and used to fill moulds or formwork. It appears in plastic state and can be moulded in any forms, whereas the hardened concrete is the one which is fully cured. For the concrete to be considered “fresh”, it should be easily mixed and transported, be uniform throughout a given batch and between batches, and be of a consistency so that it can fill completely the forms for which it was designed.

“Batched concrete mix” means that the concrete was mixed from the required concrete ingredients with either weight or volume according to the mix requirement of a consistent quality of concrete. To produce the batched concrete mix, the ingredients should be loaded into the mixer in a predefined sequence and amount. Two main types of batch mixers can be distinguished by the orientation of the axis of rotation: horizontal or inclined (drum mixers) or vertical (pan mixers). The drum mixers have a drum, with fixed blades, rotating around its axis, while the pan mixers may have either the blades or the pan rotating around the axis. In the present invention, both types of mixers can be used to produce the batched concrete mix.

In general, fresh concrete and batched concrete mix are autonomously produced in the present invention from a combination of aggregates, including sand, gravel, and crushed stone rock of different sizes, water, a chemical clinker (including gypsum addition) used as a binder for producing cement upon mixing with water, chemical additives, for example fly ash, limestone powder or slag, and chemical admixtures. The main properties of concrete are:
1) Mechanical strength, in particular compressive strength. The strength of normal concrete varies between 5 and 100 MPa. The term “high performance concrete” is used above 60 MPa, which corresponds to a force of 60 tonnes acting on a square with sides of ten centimetres. Mechanical strength depends mainly on the amount of water in concrete.
2) Porosity and density. The denser (or the less porous) the concrete the better its performance as compressive strengths and the greater its durability. The density of concrete is increased by optimizing the dimensions and packing of the aggregate and reducing the water content.
3) Homogeneity of a concrete mix, consistency, and fluidity (without lumps, segregation, or water bleeding).

Unless otherwise defined, “homogeneity” of a fresh concrete or a batched concrete mix is a percentage according to the given composition of components. The concrete mix is considered homogeneous if the samples taken from different places in the mixer contain the individual components of the mixture in equal percentages. The concrete mix homogeneity is associated with the strength of concrete and assessed by engineers using visual inspection and experience. “Concrete consistency” in the present invention refers to the relative mobility or ability of freshly mixed concrete to flow. It includes the entire range of fluidity from the driest to the wettest possible mixtures. Plastic consistency indicates a condition where applied stress will result in continuous deformation without rupture. “Slump”, “slump level”, “flow” or “flow level” is the measure of concrete homogeneity, consistency, and fluidity during the condition of the fresh concrete. It shows the flow and overall workability of freshly mixed concrete.

“Concrete workability” is a term that refers to how easily freshly mixed concrete can be placed, consolidated, and finished to a homogeneous condition with minimal loss of homogeneity. In general, the workability of concrete is determined by how fluid the concrete mix is (i.e., as the cement-to-water ratio), which is essentially the slump of concrete. It is synonymous with placing ability and involves not only the concept of a consistency of concrete, but also the condition under which it is to be placed, i.e., size and shape of the member, spacing of reinforcing, or other details interfering with the ready filling of the forms.

The more fluid the concrete, the higher the slump, and whilst the slump is seen as a measure of water content, it is typically also used as a measure of concrete consistency. Simply put, the higher the slump, the wetter the mix. Five-inch slump is very common with normal weight concrete and is a good for pumping. Slumps that are above average will cause reduced strength, durability, and permeability of the concrete, if more water is added to increase the slump level.

There are three primary factors that affect the workability of concrete:
1) The ratio of water to cement. The higher proportion of cement (or lower water-to-cement ratio) typically means a stronger concrete mix. With the right amount of cement paste, the coating of aggregates delivers a better consolidation and finish. If the mix is not hydrated adequately, the mechanical strength will be low. It is also a lot harder to place and finish. However, if too much water is used then this can lead to a negative impact on segregation and final mechanical strength, which is detrimental to the building. Typically, most mixes look to get a ratio of around 0.45 to 0.7 to achieve workable concrete.
2) The size, shape, chemical and physical properties, and quality of aggregates (stones and sand) used in a concrete mix, and contaminates as clay, dust and moisture in the aggregates and sand, affect its workability and the performance of the concrete. As aggregate surface area increases, the more cement paste is needed to cover the entire surface of aggregates and the increased water demand. So, concrete mixes with smaller aggregates will be typically less workable when compared to larger sizes. Crushed aggregates with decent proportions tend to bond best with the cement and deliver decent workability.
3) Chemical admixtures are used in concrete to improve and to adjust the properties of the fresh and harden concrete, things like mechanical strength, setting times and workability and handling of the concrete mix. A few examples include plasticizers to help regulate concrete consistency, air entrainers (which are mostly surface-active substances, such as soaps from natural resins or synthetic non-ionic and ionic tensides with defoaming agents, that are used to entrain microscopic air bubbles into the concrete and protect it from frost) to improve freeze/thaw resistance and internal curing to help reduce damage such as cracks and strength loss.

As used herein, the term “chemical admixture” includes chemical adjuvants added during continuous and ongoing concrete mixing to enhance or to adjust the workability (slump) of the fresh concrete or to affect other physicochemical properties of the concrete as mentioned above (setting times, homogeneity). Chemical admixtures are added to concrete batch during mixing concrete according to the progress of the hydration, aggregates water absorption, environmental conditions, and chemical and physical properties of the raw materials in concrete, over the time and transportation of the concrete to the construction sites and at the sites before unloading the concrete. They improve concrete quality, adjust the required workability, manageability, acceleration, or retardation of setting time, among other properties that could be altered to get specific results. Non-limiting examples of the dispersants suitable for use in the present invention are polycarboxylate polymer and naphthalene sulphonate.

In particular embodiments, the chemical admixtures used in the present invention are selected from the group consisting of:
(a) chemical dispersants suitable for dispersing a concrete mixture and thereby maintaining the desired levels of the physicochemical parameters of concrete;
(b) surfactant admixtures suitable for altering the physicochemical parameters of the produced concrete as hydration stabilisers (retarders) formulated to slow the hydration rate during the concrete production over extended periods of time (in more effective way);
(c) cement accelerators suitable for speeding the setting times (initial and final) and consequently, a cure time of the cement, thus accelerating the hydration of the cement binding process with water, adjusting the rate and degree of the binding reaction of the cement and water, and binding materials within the concrete (in the presence of a chemical clinker used as a binder for producing the cement upon mixing with water). In addition, there are accelerator that are also added to prevent freezing of water inside the concrete mixing tank in cold areas, and thus enable the production of concrete at low temperatures;
(d) viscosifiers suitable for increasing viscosity of the fresh concrete or the batched concrete mix, thereby causing a reduction in water excretion and segregation, and increasing homogeneity of the concrete;
(e) air entrainer surfactants for air entrapment, suitable for increasing the air content in the fresh concrete and adjusting viscosity of the concrete; and
(f) chemical inhibitors.

In particular regard, a “cement accelerator” is an admixture for the use in concrete, mortar, plasters, or screeds. The addition of an accelerator speeds the setting times (initial and final) and thus, cure time starts earlier. This allows concrete, for example, to be placed in winter with reduced risk of frost damage and in a shorter time. Concrete is damaged if it does not reach to the required setting times or to a strength of 10-25 MPa before freezing. Typical chemicals regularly used for acceleration are calcium nitrate (Ca(NO₃)₂), sodium thiocyante, sodium silicate, calcium nitrite (Ca(NO₂)₂), calcium formate (Ca(HCOO)₂) and aluminium compounds. Novel alternatives include cement based upon calcium sulphoaluminate (CSA), which sets within 20 minutes and develops sufficient rapid strength that an airport runway can be repaired in a six-hour window and be able to withstand aircraft use at the end of that time, as well as in tunnels and underground, where water and time limitations require extremely fast strength and setting.

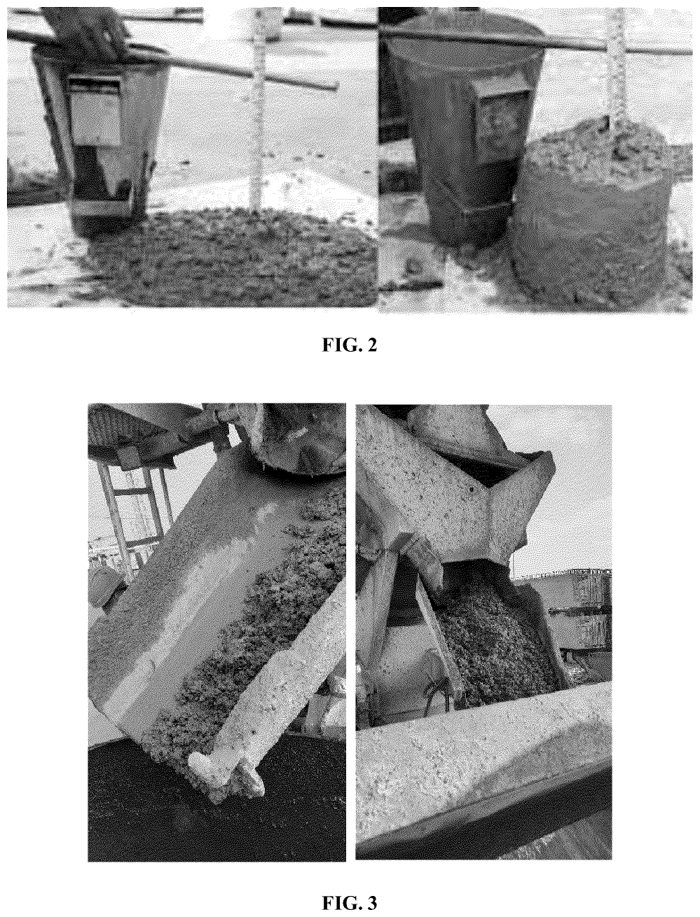

The slump test is one of the tests used to measure the workability and assess the consistency of fresh concrete. There are other techniques to test workability such as a flow for very high workability concrete, such as self-compacting concrete type (SCC). Generally, it is used to check that the correct volume of water has been added to the mix. Conventionally, workability of concrete is determined by checking the slump level of concrete using a cone as shown in FIG. 2. The slump test of concrete includes the following steps:
(1) The cone is positioned on the base plate with the smaller aperture uppermost.
(2) Freshly supplied concrete is poured into the cone to roughly one third of its depth (100 ml).
(3) The concrete is tamped using 25 strokes of the steel rod.
(4) Further concrete is added to fill the cone to about two thirds depth (another 100 mm of concrete).
(5) The concrete is tamped again using 25 strokes of the rod just penetrating the layer below.
(6) The cone is filled to the top and tamped using a final 25 strokes with the steel rod.
(7) Using the tamping rod slid across top of the cone the surface of the concrete is “struck off” level with the top of the cone.
(8) The cone is carefully lifted upwards, clear of the concrete and placed, upside-down beside the concrete.
(9) After about a minute, the unrestrained concrete will settle downwards or “slump” due to gravity.
(10) The steel rod is used to span the inverted cone and towards the slumped concrete.
(11) The height difference between the steel cone and the slumped concrete is measured. This difference, which is measured to the nearest 10 millimetres, is actually the slump level.

In the present invention, the slump test is carried out directly on the concrete production platform of the invention. Slump test results can be classified in four types:
1) True slump, which is the only slump that can be measured in the test according to standards. The measurement is taken between the top of the cone and the top of the concrete once the cone has been removed.
2) Zero slump, which is the indication of a very low water to cement ratio that results in “dry” mixes. This type of concrete is largely used for road construction.
3) Collapsed slump, which indicates that the water to cement ratio is too high, for example, the concrete mix is too wet, or it is a high workability mix.
4) Shear slump, which indicates an incomplete result, and the concrete needs to be retested.

Unless otherwise defined, “concrete stability” in the present invention refers to the ability of the produced concrete to remain stable and homogeneous during handling, transportation, and discharge at the constructive sites without excessive segregation. Stability of the concrete is characterised by the bleeding and segregation tendencies of the concrete using a direct method of measurement, for example the method based on floatation over carbon tetrachloride.

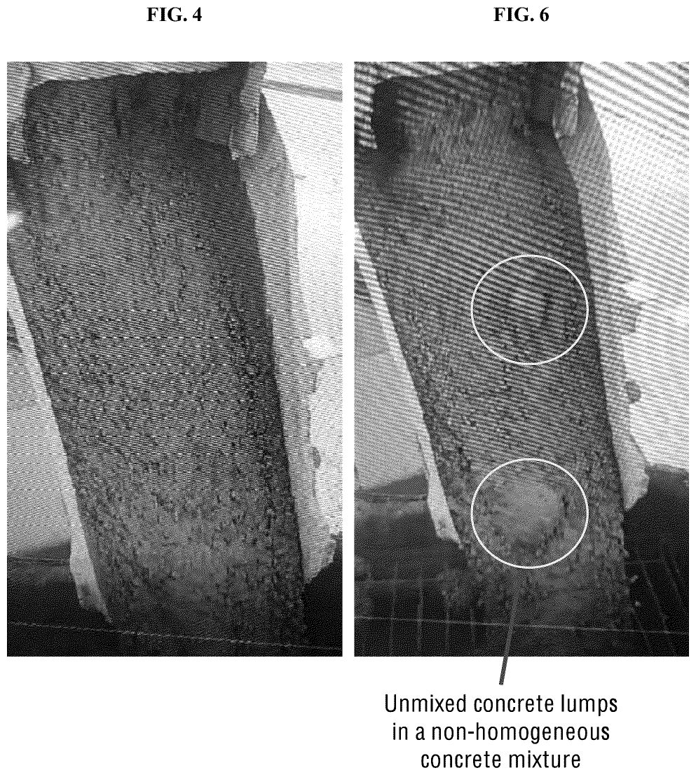

Customers and buyers of concrete usually order a certain mechanical strength and slump level of the concrete according to the required specifications of the concrete to ensure its quality. Concrete systems produce concrete and supply it to the customers. The slump level of concrete usually decreases from the moment the concrete is prepared due to the hydration of cement in the concrete with water, water absorption by aggregates, admixtures absorption by aggregates in the concrete, change of ambient temperature, impurities such as clays and organic materials in the aggregates and sand used to make the concrete, reduction performances of the different types of admixtures mixed during the load of the cement water and aggregates in the initial mixing in the concrete system. Therefore, the slump level of concrete indicating its homogeneity, consistency and fluidity decreases with the time of production and transportation of the concrete until the concrete arrives at the construction site and is used. FIG. 3 shows images of the zero-slump (dry) concrete discharged at the construction site and having a much lower slump level than required, and FIG. 4 shows an image of concrete provided with a suitable slump after water was added to the concrete directly at the construction site, which reduced its mechanical strength.

Right after the mixing of all the concrete components, or during production and transportation of the concrete with a certain slump level in the concrete-production system of the present invention and during the discharge of the concrete at the construction site, it is possible, using the continuous monitoring system of the invention, comprising at least two sensors selected from an imaging camera, a hydraulic pressure gauge, a temperature gauge, and an acoustic sensor, to determine or to simulate the concrete slump and the concrete slump reduction of the produced concrete.

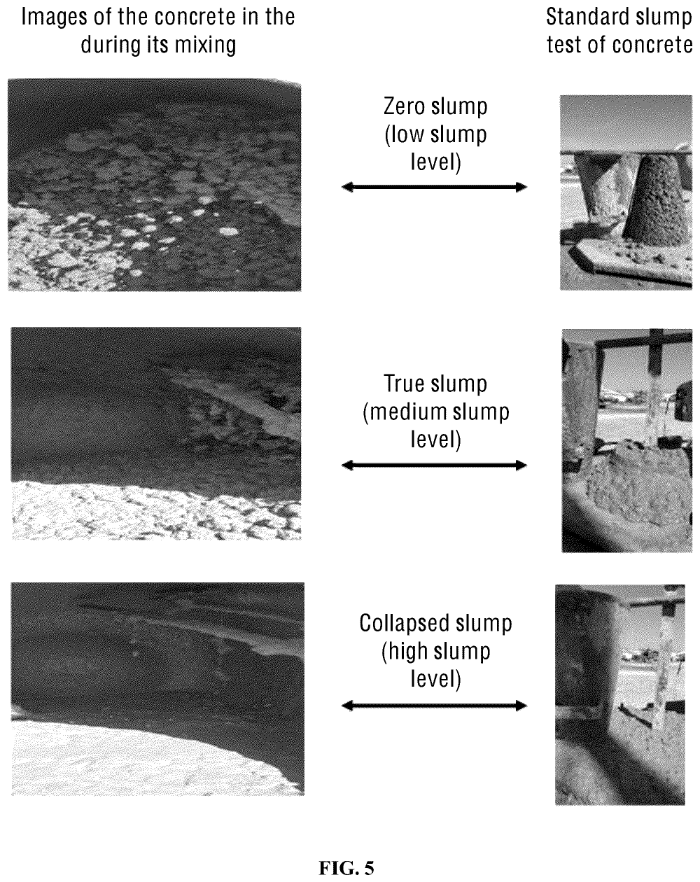

The slump level and other characteristics of the freshly prepared concrete can be assessed by AI-controlled sensors as the image processing and finding a correlation between the image of the concrete fluidity and the slump test performed as mentioned above and further detailed. Reference is now made to FIG. 5 showing on the left, three types of different mixed concrete, and, on the right, three corresponding images of the slump level of the concrete as tested. The difference in the slump level of the concrete can be clearly seen just by looking at these images of the concrete.

Apart from the slump level of concrete, the quality of concrete is affected by a number of factors. FIG. 6 shows concrete that has not been mixed enough and therefore lumps can be seen in the concrete. These lumps will be poured into a building structure and will substantially worsen the properties of the hardened concrete in the structure, which will eventually deteriorate because of these lumps.

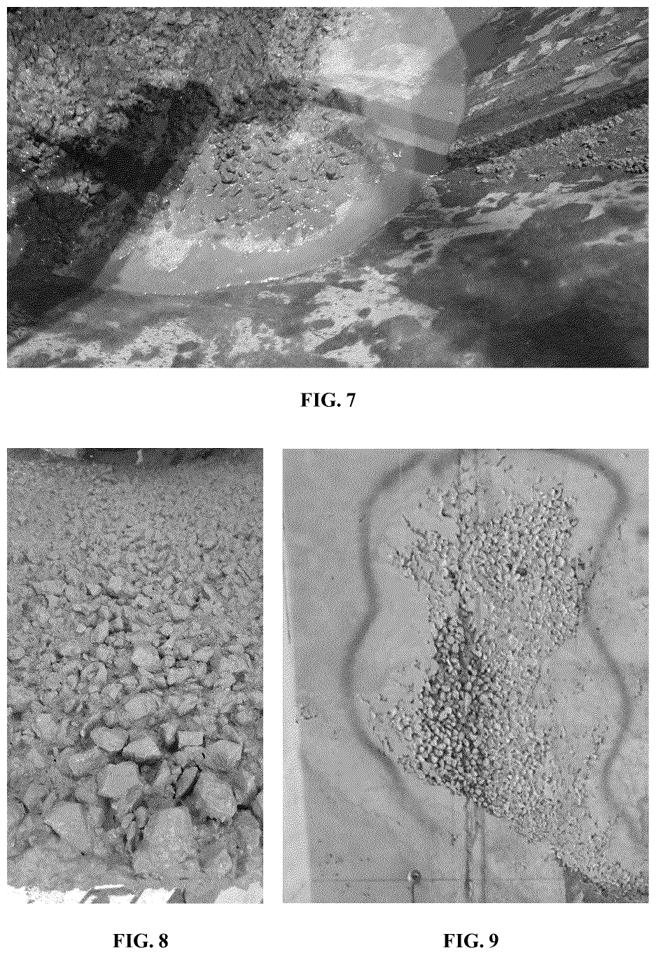

FIG. 7 shows an image of decomposed concrete having a collapsed slump and a lot of water bleeding and segregation. FIG. 8 shows an image of an incorrect grading of aggregates in the concrete and therefore a concrete mixture with segregation (separations of the concrete components) can be seen. Examples of these failures in concrete preparation essentially impair the durability and quality of the concrete (significantly reduced mechanical strength, water permeability into the structure, corrosion of the iron bars, etc.). FIG. 9 shows segregation of the hardened concrete in the wall, in one of the newly built structures.

In a certain embodiment of the present invention, a continuous monitoring system of the present invention configured to monitor, during production of the concrete, one or more properties of the concrete within the concrete mixer tank, comprises at least two sensors selected from the group consisting of:
(a) Imaging, video and thermal camera that continuously gathers visual information, thermal information, and thermal profile of the concrete at any time before transportation, during transportation, prior to discharge and during the discharge of the concrete at a construction site;
(b) An acoustic sensor that continuously examines changes in a sound level, frequency and duration, and a sound of low and full load of the concrete inside the concrete mixer, and thus monitors the workability, homogeneity, cohesion, segregation, and water separation of the concrete;
(c) A hydraulic pressure gauge that indicates a hydraulic pressure of the concrete inside the concrete mixer tank and a hydraulic load intensity on the mixer motor during loading and prior to discharge of the concrete while mixing at a high rotation frequency of the mixer tank from about 5 rpm to about 95 rpm, and during transportation while mixing at a low rotation frequency from about 4 rpm to about 12 rpm, where the hydraulic pressure and hydraulic load intensity are indicators of the workability of the prepared concrete. The hydraulic pressure gauge is therefore configured to provide an additional indication to simulate the workability of the concrete; and
(d) A temperature gauge that continuously monitors and controls the concrete temperature and surrounding temperature outside the mixed concrete, and thus monitors a hydration progress, including the degree of hydration, rate of heat of hydration and slump reduction of the concrete, and water absorption by aggregates of the concrete.

An exemplary thermal imaging camera that produces images, videos, thermograms and thermal profiles of the concrete, used in the system of the present invention is a forward-looking infrared (FLIR) camera, which is capable of monitoring the consistency of the fresh concrete or concrete batched mix. This type of cameras does not “see” water in the concrete, but rather visualises the impact water has on the temperature of surfaces around them due to the evaporation process.

In another embodiment, the continuous monitoring system of the present invention further comprises a tachometer or a revolutions-per-minute (RPM) gauge installed on the mixer for indicating a centrifugal force or rotation speed and tracking progress of the concrete mixer tank, and additional simulation of the slump level.

In the present application, the terms “tachometer” and “RPM gauge” are considered entirely equivalent and used therefore interchangeably. In general, the RPM gauge or tachometer is a device measuring the centrifugal force or rotational speed of a shaft or disk, as in a motor or other machine. In the concrete mixer truck, the RPM gauge measures the centrifugal force or rotational speed of the concrete mixer tank of the truck. This device usually displays the revolutions per minute (RPM) on a calibrated analogue dial, but digital displays are increasingly common and also can be used to indicate mixing or unloading of the concrete and to evaluate the volume remaining in the mixing tank.

The hydraulic pressure gauge and RPM gauge installed on the concrete mixer allow an additional indication to simulate the slump level. The control system of the present invention determines the slump level and the slump reduction and an amount of the concrete admixture, which should be added in order to increase and adjust the slump level to the desired level without adding water to the concrete. In addition, the control system determines the volume of concrete left in the concrete tank by calculating the estimated volume discharged (offloaded) by the number of the discharge rounds and a number of empty blade spiral revolutions.

In yet further embodiment, the system of the present invention further comprises a communication module installed into or connected to the computing unit and configured to:
continuously receive and process data from the continuous monitoring system in a form of thermograms, images, video and audible or acoustic signals, temperature and temperature gradient, and hydraulic pressure, and
simultaneously transmit readable information to an external storage device or user's interface in a form of text, graphics, or audible signals, and updating or alerting the user if any action on the user's side or manual intervention is required.

In some embodiments, the communication module is a wireless connection module. It can be either Bluetooth® or NFC providing the short-range wireless communication between the computing unit and an external storage device or the user's interface for up to 20 m. If this module is Wi-Fi, the connection can be established with a network for up to 200 nm, while GSM allows the worldwide communication to a cloud. The external storage device or user's interface may be any mobile device or gadget, such as a smartphone or smart watch. It may also be a desktop computer, server, remote storage, internet storage or cloud. The communication module may be a wireless connection module used as a standalone device or integrated in the computing unit or in the external storage device.

Thus, the present application describes the AI-driven control and monitoring system for constantly examining the concrete slump and homogeneity, monitoring the decrease of fluidity of the concrete as a function of time and correlating it to the slump or flow level ordered by the contractor. This system proactively monitors the physicochemical properties of fresh concrete by assessing its slump level and homogeneity using image processing and identifying the reasons of the concrete failure while it is still being produced in the concrete system, transporting the concrete in the concrete truck to the construction site and at the time of discharging the concrete into the building structure or pump. The monitoring and adjusting process is autonomous and continuous, which means it is autonomously and continuously carried out by the AI-driven system of the invention until the concrete is discharged (offloaded) or prior to that, if so desired.

The AI-driven control and monitoring system allows having a regular image, a video or a thermogram of the concrete to be obtained at any given time and makes it possible, by processing the image, to autonomously assess the slump or flow level of the concrete at any given moment and without checking by an operator, truck driver or quality controller at the construction site, or to proactively detect conditions of defective concrete preparation and improper handling of the concrete mixes containing non-homogeneous concrete, lumps, water bleeding, segregation of aggregates, the slump level too high or too low, and the like.

In some embodiments, the data generated by the AI-driven control and monitoring system is dependent on thermogram parameters, time, and time intervals of the audible (acoustic) signals, temperature and temperature gradient, and hydraulic pressure.

In a further embodiment of the present invention, the concrete monitoring and quality control system is installed together with other components of the production system on the stationary platform or mobile platform of a truck suitable for transporting the fresh concrete or the batched concrete mix to a construction site and automatically discharging (offloading) the concrete at the construction site.

In yet further embodiment, the concrete monitoring and quality control system of the present invention further comprises an imaging or video camera installed on the mobile platform outside the concrete mixer tank, for monitoring events and activities outside the mixer truck. These events and activities outside the mixer truck comprise activities of factory and construction personnel, factory and laboratory workers and engineers taking samples of the discharged concrete for determining the quality of the concrete, and an operator and driver of the mobile platform.

The adjustment of the slump or flow level is enabled by four major steps of a method encoded by an algorithm of the present invention:
I. Determination of the type of chemical admixture and/or combining admixtures to be fed to the mixer with the rate, dosages, and time schedule of feeding of different admixtures according to the type of cement, quality of aggregates, environmental conditions, time from the beginning of the concrete production, transportation time, hydration rate, and percentage of the main cement components. Amounts of the added chemical admixtures are determined by the proactive AI system of the invention.
II. Simulation of the slump or flow level and identifying between the actual slump and the desired slump level at any time.
III. Adjustment of the slump level using a chemical admixture (not water) by the AI-driven control and monitoring system of the invention with the aforementioned output data in a form of autonomous commands to the dispensing mechanism to maintain the desired physicochemical parameters of the concrete production process, quality, consistency, and stability of the produced concrete.

In most of the embodiments, the artificial intelligence involves a training process that includes training the machine-learning model with the aforementioned input data sets of the present invention received from the sensors, wherein each data set is based on a single time stamp and represents the predictions that will be made by the trained machine-learning model. This training of the machine-learning model correlates the input data with pre-determined labels, including the required quality, consistency, and stability of the fresh concrete or the batched concrete mix being produced in the mixer tank during the transportation and prior to the discharge; decrease in quality of the aggregates and change in composition of the produced concrete; a computed volume of the concrete in the concrete mixer tank; a concrete temperature; sound (audible) parameters changes that indicate “drying” and homogeneity of the concrete; required physicochemical parameters of the produced concrete and deviations from the physicochemical parameters of the concrete production process. After being trained, the proactive machine-learning model (e.g., a deep-neural network) predicts a set of actions including adding certain chemical admixtures at specific amounts and at particular intervals of time into the mixer tank to maintain the desired quality and stability of the produced concrete in the concrete mixer tank.

The levels of and deviations from the required physicochemical parameters of the produced concrete and the corresponding required examples of actions are summarised in the following table:

TABLE 2
Examples of Al Autonomous Actions.

| Physicochemical parameter changes | Required actions |
|---|---|
| A workability reduction of the | A specified amount and type of a |
| concrete and changes in the desired | chemical admixture is to be added |
| slump/flow level as a result of | to the concrete in the mixer tank |
| increased pressure on the mixing | without addition of water. |
| motor or increased temperature, | |
| increased sound degree level and | |
| image analysis | |
| A bonding time with the cement | 1) Addition of hydration stabilizer |
| | and chemical dispersion admixture |
| | as a function of time from the |
| | beginning of the concrete |
| | production and also adding in |
| | certain amounts and at certain |
| | intervals of time, for example |
| | adding hydration stabiliser at |
| | several time intervals and adding |
| | dispersion admixture after about |
| | 5 to 20 minutes from the beginning |
| | of the concrete production in the |
| | mixer tank. |
| | 2) Adding a cement accelerator |
| | before unloading the concrete upon |
| | arrival at the construction site. |
| A desired initial concrete strength | A rate profile (delay or |
| or fast/slow setting times. | acceleration) for the addition of an |
| | admixture is to be changed, |
| | selected, and applied. |
| An air content of the concrete in the | Addition of an air entrapped agent |
| mixer tank | through a foam generator system at |
| | the beginning of concrete |
| | production with the first 40-80% |
| | water or during the transportation |
| | or upon arrival at the construction |
| | site. |
| A degree of hydration as a fraction | A one-time addition of a certain |
| of cement that has fully reacted | amount of a hydration stabiliser |
| with water during the binding | admixture at the beginning of the |
| process. | production process and during the |
| | transportation of the concrete at |
| | the certain time intervals and |
| | according to the indication from |
| | the control system and the time |
| | remained until the concrete is |
| | discharged at the construction site. |
| The fineness of the produced | A corresponding dosage amount, a |
| cement upon mixing with water, a | number of dosages, a time interval |
| rate of a heat evolution of the | between the dosages and a rate of |
| cement in the concrete and viscosity | addition of a hydration stabiliser |
| of the concrete | into the mixer tank is to be |
| | changed, selected, and applied. |

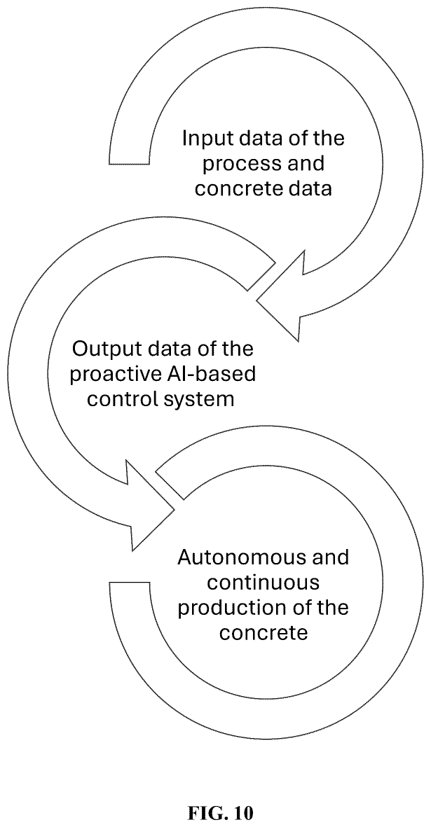

FIG. 10 schematically shows the concrete production process of the present invention. Thus, the autonomous actions carried out by the proactive AI system of the invention are to add water, a chemical dispersant or the chemical admixture containing said dispersant to the concrete mixer tank, in an amount required to maintain or adjust the desired quality and stability of the produced concrete, and further perform a re-inspection. The driver or operator can be optionally alerted upon receipt of the information from the AI system about the decrease in the quality of the aggregates and the change in the composition of the produced concrete.

Using a closed control circuit that receives slump data and slump decrease at any time, it is possible to adjust the concrete mixture fluidity and homogeneity by adding a suitable chemical admixture, such as a chemical dispersant, to ensure concrete supply at the desired slump level and without uncontrolled addition of water at the construction site. This will impart much better control of the quality of the concrete.

In another aspect of the present invention, a method for producing concrete, comprising:
(a) Producing concrete in a concrete mixer tank disposed on a concrete production platform;
(b) Continuously monitoring during the concrete production and transport, environmental conditions and one or more properties of the concrete within the mixer tank using a continuous monitoring system comprising at least two sensors;
(c) Autonomously determining, using a proactive AI-based control system, a type of admixture to add, a quantity of the admixture to add, and a time to add the admixture to maintain the one or more properties of the concrete within a desired range based on sensor real-time data received from the continuous monitoring system;
(d) Dispensing the admixture into the mixer tank at the determined time, as determined by the AI-based control system; thereby minimising addition of water to the concrete while maintaining the one or more properties of the concrete within the desired range.
wherein the proactive AI-based control system comprising:
   A reinforcement learning (RL) agent configured to learn an optimal policy for adding the admixtures and water based on the real-time sensor data received from the continuous monitoring system, concrete mix design parameters, environmental conditions, and time elapsed since mixing;
   A supervised learning (SL) model configured to predict temporal changes in the one or more properties of the concrete based on the real-time sensor data during the concrete production and transportation and on historical concrete production data and admixture history;
      wherein the reinforcement learning agent uses the predictions from the supervised learning model to make the determination and inform its decision-making process.

In the method of the present invention, the proactive AI-based control system comprises a reinforcement learning agent configured to learn an optimal policy for adding the admixture based on the data received from the continuous monitoring system; and a supervised learning model configured to predict temporal changes in the one or more properties of the concrete during the transporting based on historical concrete production data. In some embodiments, the reinforcement learning agent uses the predictions from the supervised learning model to make the determination. In other embodiments, the method of the present invention further comprises autonomously determining a quantity of water to add to the concrete based on the data received from the continuous monitoring system.

In a specific embodiment, the concrete physicochemical parameters in the method of the present invention are selected from the group consisting of:
a slump or flow level (workability) reduction of the concrete computed from a slump simulation and continuous changes in the slump level with time;
an amount and type of said one or more chemical admixture to be added to the concrete in the mixer tank in accordance with required specifications of the prepared and mixed concrete and the properties of aggregates and cement used for the production of the concrete, in order to maintain or adjust a specified workability of the concrete to a required level without addition of water;
a bonding time with cement;
an initial and final setting times of the concrete;
a rate profile (delay or acceleration) for addition of an admixture in order to maintain or adjust to a required level of the desired concrete strength;
an air content of the concrete in the mixer tank;
a degree of hydration of the concrete to a predetermined level computed from the visual information, thermal information, and thermal profile of said concrete and computed as a fraction of a chemical clinker that has fully reacted with water during the binding process;
a fineness of the produced cement upon mixing with water affecting a rate of a heat evolution of the cement in the concrete and viscosity of the concrete, said heat evolution is proportional to a change in the concrete viscosity during the concrete production process, and said parameters are used to compute a dosage amount, a number of dosages, a time interval between the dosages and a rate of addition of a hydration stabiliser into the mixer tank; and
a homogeneity and consistency of the concrete including presence of the aggregates in the concrete, density and concrete height, size, shape, and colour of the aggregates inside the concrete, water bleeding, and segregation of the concrete.

In a certain embodiment, the concrete physicochemical parameters in the method of the present invention are correlated in the AI system:
with an amount of water to add to the concrete in the concrete mixer tank in order to reach a required water-to-cement ratio and not to exceed this ratio; and
with an amount of a chemical admixture to continuously add to the produced concrete at predetermined dosages and intervals of time, to disperse said concrete and thereby, increase the slump level of the concrete to the desired slump level, without adding water.

In some embodiments, the proactive AI system used in the method of the present invention involves a training process that includes training the machine-learning model with the aforesaid input data sets, each data set is based on a single time stamp and represents the predictions that will be made by the trained machine-learning model. Said training of the machine-learning model correlates the input data with pre-determined labels, including the quality, consistency, and stability of the concrete being produced in the mixer tank during the transportation and prior to the discharge; decrease in quality of the aggregates and change in composition of the produced concrete; a volume of the concrete in the concrete mixer tank; a concrete temperature; sound changes that indicate drying of the concrete; and deviations from physicochemical parameters of the concrete production process.

In a specific embodiment, the exemplary concrete production process of the present invention, including the sensing, control, and operation of the system comprises the following actions:
(1) Recommended order of loading:
   a) Addition of all the aggregates and sand with 60-80% of the total water. It is mixed until a uniform mixture is obtained to allow maximum water absorption by the aggregates plus sand and then the required cement amount plus 0.1%-0.5% hydration stabiliser (retarder). The amount of hydration stabiliser (retarder) is added according to the solid content and chemical type of the hydration stabiliser (retarder). It is recommended that approximately half or a third of the total hydration stabiliser (retarder) be needed in the concrete.
   b) Adding the aggregates, sand, and cement plus 0.1%-0.5% hydration stabiliser (retarder). The amount of hydration stabiliser (retarder) is added according to the solid content and chemical type of the hydration stabiliser (retarder). Approximately half or a third of the total retarder needed in the concrete is recommended.
   c) Two initial times are taken in the input data of the system: the time contact of water with the aggregates and the time contact of water with clinker/cement.
(2) The maximum water-to-cement ratio which is defined in the AI control system according to the type of concrete (Max W/C). During all the stages from the beginning of the concrete production and during the concrete's transportation and discharge, the AI-driven control system continuously computes the total added water to the mixer, including the water amount in the admixtures, to estimate the ongoing water cement ratio. The system will not allow the water-cement ratio to increase above the allowed maximum (threshold value) of the water-cement ratio.
(3) Dosages of admixtures are added according to the AI system experience gained, the machine learning model trained, and the historical data of first tests performed in the laboratory.
(4) A maximum allowed water-to-cement ratio is determined for each type of concrete.
(5) A computation is made considering the total water added to the stationary system mixer and during the aggregates' transportation and moisture. The computed water is determined by reducing the water absorbed by the aggregates and sand.
(6) The historical concrete mix data, the aggregate and sand data, the type of concrete, the required slump/flow, the needed strength, and the amounts of water and admixtures added to the mixer are recorded and displayed by the system. In addition, the real-time data of the various sensors are monitored by the AI system from the beginning of loading until the end of the discharge of the concrete.
(7) Continuous production of concrete in the concrete mixer is entirely autonomous and performed by the proactive AI system of the present invention. Optionally, limiting changes and additions of materials are conducted after receiving approval from a qualified entity outside the AI system. The system has a range of allowed quantities of the materials to be added (safeguards).
(8) A contractor can use the proactive AI-driven control system of the present invention at the construction sites to assess the quality, consistency, and stability of the fresh concrete received at the construction site.
(9) The proactive AI-driven control system of the present invention can be used together with the stationary concrete system to control the properties of the concrete before its uploading for the transportation to the construction site.

To sum up, the system and the method of the present invention allow:
Reducing the amounts of chemical admixtures used in the process.
Cost reduction of expensive chemical admixtures, which are normally added to the concrete in the system.
Working with lower-quality and lower-cost aggregates.
Prevention of manual intervention in the concrete production by an operator, a driver, or any other person working with the concrete, including adding water to the batched concrete at the construction sites, and reducing the safety factors.
Continuous monitoring of the concrete quality and controlling the concrete properties in addition to the slump and flow levels, such as segregation and water bleeding, throughout the concrete production during its transportation and offloading at the construction sites, and not only in the stationary concrete systema before the truck leaves.
Better control of cement contact times and air content and reducing the amount of cement used (possibility of reducing the ratio of water to cement) by more intelligent use of chemical admixture throughout the production and transportation.
Production of concrete in a lower slump and increasing it before the concrete discharge (offload). This results in savings in an additional concrete cost. Maintaining the homogeneity of the concrete batched mix and preventing water bleeding.
Supervision and control of operations at the construction sites upon offloading of the fresh concrete or the concrete batched mix.
Development of the system of the present invention for contractors' companies to simulate and control the concrete delivered by the concrete companies.
Improved quality control of the produced concrete.
Altering the composition of aggregate mixtures in the production of concrete depending on the quality of the aggregates and sand obtained and neutralizing the negative effect of pozzolanic materials.
Maintaining the stability of concrete properties over a longer period of time. adjusting the desired setting times of the concrete through the transportation and the use of retarders.
The ability to use various types of admixtures to produce all types of concrete in the desired properties in the building sites.
The ability to have stable air content in the construction site.
The ability to have stable properties in all types of weather.
The ability to have stable properties of the concrete using all types of cement (I, II, III etc.) and using different types of chemical additives and pozzolanic and other active materials such as fly ash, slag, limestone powder, oil shale metakaolin etc.
The ability to reduce cement amount significantly.

The concrete monitoring and quality control system of the present invention has a number of notable pros:
1) Avoiding addition of water to the concrete mix at the construction site, in order to disperse the concrete in an uncontrolled manner. That will reduce the number of failures in the mechanical strength of the concrete and allow the reduction of cement and reduction of safety factors.
2) Reducing the safety coefficients or the amount of cement in the concrete mixture, thus reducing considerable cost and environmental pollution which is reflected in the low consumption of cement.
3) Ability to control the quality of the concrete by determining the fixed water-to-cement ratio, and further adding a chemical admixture (dispersant) (instead of water) that would allow stability and control of the concrete properties.
4) Control and monitoring of the concrete mixture throughout the entire production and transportation and at the construction site, wherever the concrete is located and during all time of its transportation and use.
5) Savings in expensive chemical admixtures used to maintain the proper slump level.
6) Full control and monitoring of the concrete condition by a building contractor.
7) Ability to produce stable concrete mixture having stable performances.
8) Ability to produce concrete having the proper desired performances of the concrete defined by the contractors and the workers in the construction sites.

In a specific embodiment, the type of concrete produced by the method of the present invention is selected from the group consisting of:
Ready-mix concrete (RMC)—all types of concrete transported from a stationary concrete plant to construction sites. For example, various strength concrete, various workability concrete, self-compacting concrete (SCC), floor concrete, high initial-strength concrete, high final-strength concrete, pump concrete, boiler concrete, concrete with various aggregate grades, concrete with all types of cement and cement substitutes, etc.
Factory-made concrete (precast concrete)—concrete that is produced in a plant and poured at the production site—concrete for protection, capstones, concrete blocks, sewer infrastructure, water mains, shelters, etc.
Concrete produced on a 3D printer.
Geopolymer concrete—concrete that does not contain cement, but is more like coal ash, slag, metakaolin and chemical additives such as caustic soda and sodium silicate.
Concrete produced in a stationary concrete plant or concrete produced on the construction site.

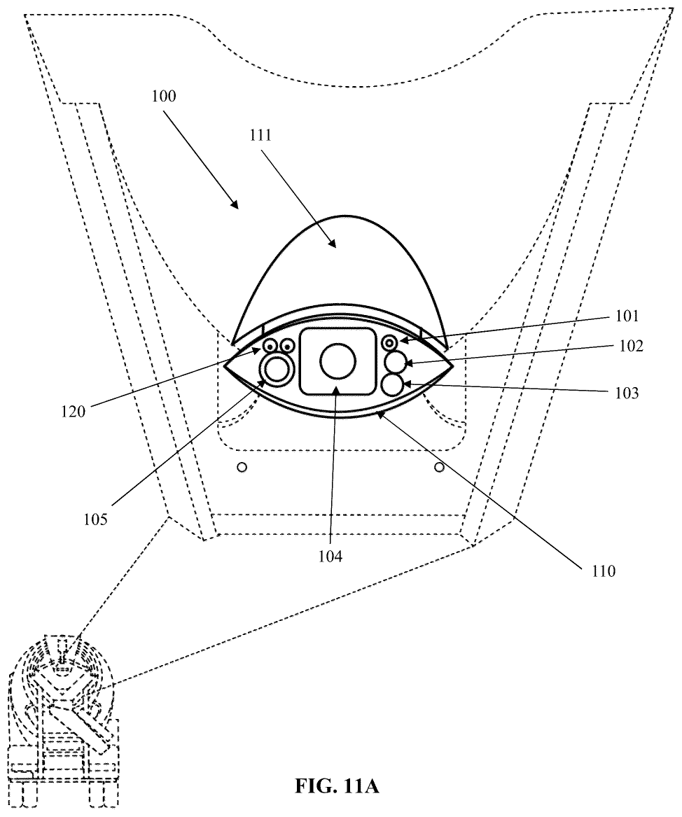

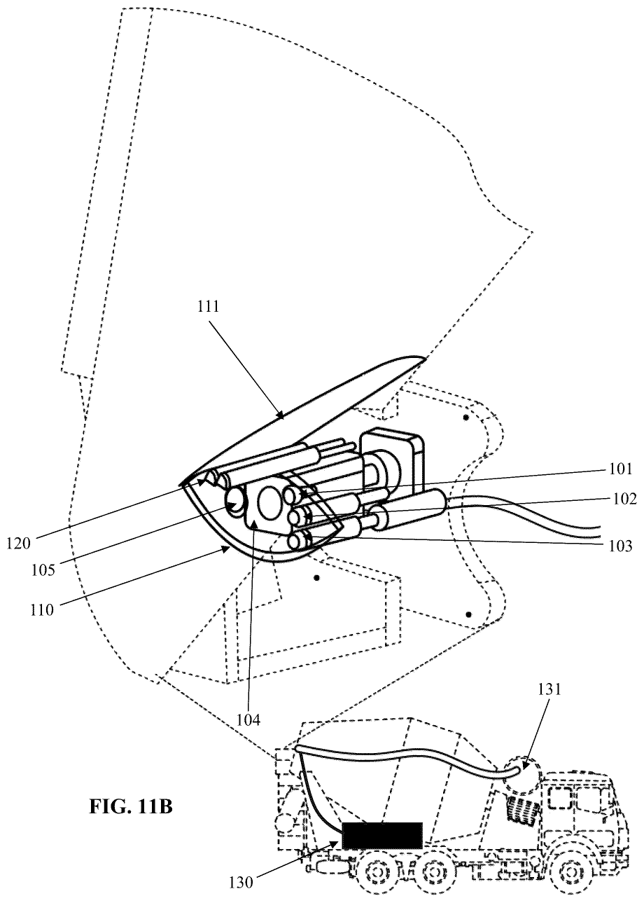

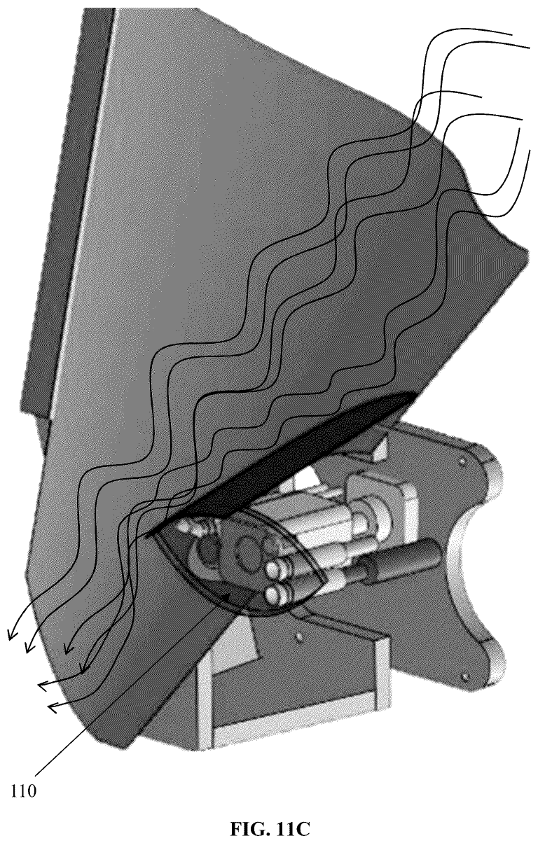

Reference is made to FIG. 11A depicting a front view of the continuous monitoring system assembly (100), shown in context at the opening of a concrete mixer tank (in dotted lines). The assembly (100) includes a housing which contains a sensor array. The sensor array comprises a camera (104) positioned to have a direct line of sight into the concrete mixer tank, a microphone/acoustic sensor (103) designed to record sound from the concrete, and a temperature gauge/sensor (102) configured to measure the temperature of the concrete. The housing itself features a light source (105) to illuminate the concrete for the camera (104). A protective upper cover (111) is present to shield the internal components and allow materials to slide over it. A transparent front cover (110) enables light to pass through and allows the camera (104) to capture images. At least one water cleaning nozzle (101) is positioned to wash the transparent front cover (110) of concrete residue and other dirt.

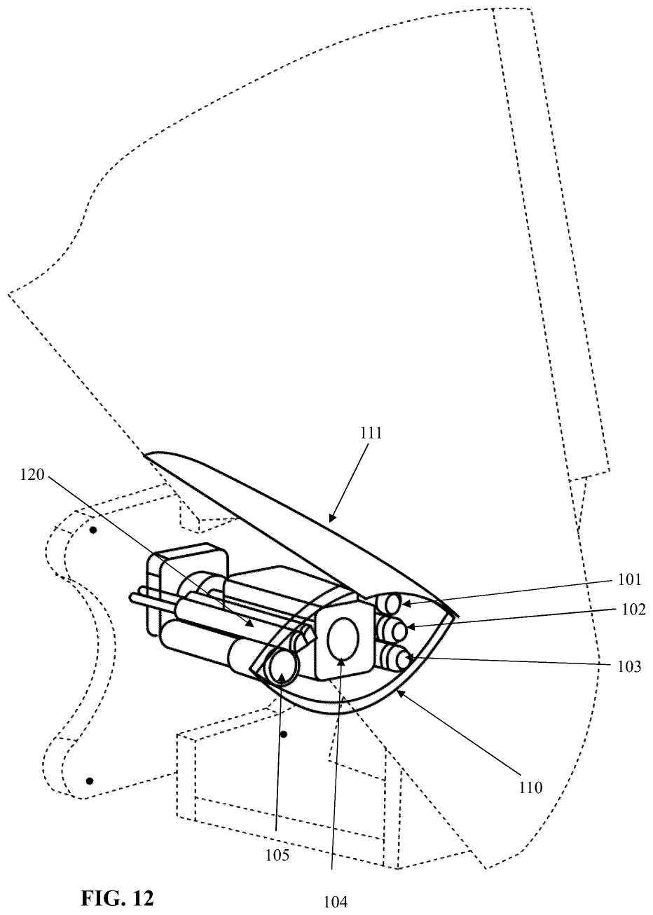

Reference is further made to FIGS. 11B and 12 showing perspective views of the continuous monitoring system assembly (100), detailing the arrangement of the camera (104), microphone/acoustic sensor (103), temperature gauge/sensor (102), light source (105), and water cleaning nozzle (101) within the housing. These figures also show the protective upper cover (111) and transparent front cover (110). FIG. 11B further indicates the assembly's placement at the opening of the concrete mixer tank and illustrates a fluid connection between one or more chemical admixture reservoirs (130, 131) and the mixer's tank opening, for supplying water to the cleaning nozzle (101) or for adding chemical admixtures into the mixer tank via a separate nozzle (120).

Reference is now made to FIG. 11C presenting a detailed perspective view of the assembly (100), specifically highlighting the intended flow path of fluids and concrete materials over the protective upper cover. This visualization illustrates how the cover's shape deflects the bulk of material, helping to keep the transparent front cover (110) relatively clean.

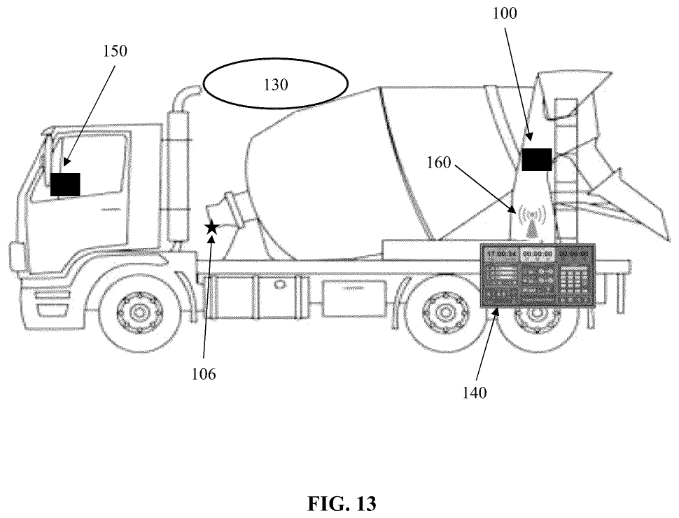

Reference is also made to FIG. 13 showing the potential placement of the monitoring system assembly (100) and the cabin-mounted display (150) of the concrete production system according to the invention. The assembly (100) is placed at the rear of the mixer truck, mounted in the raw material feeding chute, a control unit (140) is shown on the side of the truck, and a cabin-mounted display (150) is located within the driver's cabin.

In addition, FIG. 13 illustrates the overall concrete production system of the present invention with the selected components. A chemical admixture reservoir (130) represents the tanks for various admixtures and water. A control unit (140) is shown on the side of the truck, capable of receiving and sending signals wirelessly (160). A hydraulic load intensity sensor (106) is indicated near the hydraulic drum rotator.

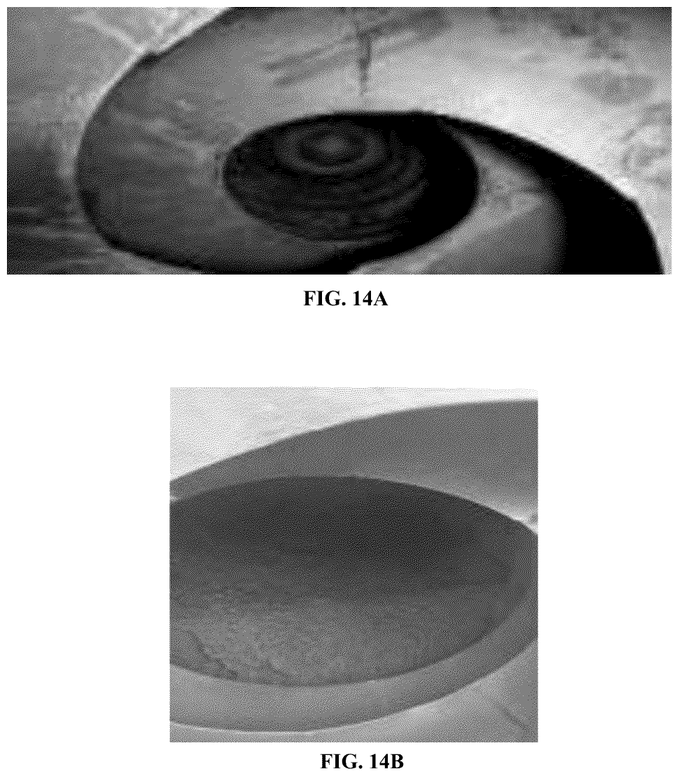

Finally, FIGS. 14A and 14B provide visual examples of the internal views of the concrete mixer tank that can be captured by the camera (104). FIG. 14A shows the spiralling interior of the mixer drum, while FIG. 14B shows a view of the wet concrete within the mixer drum during transport.

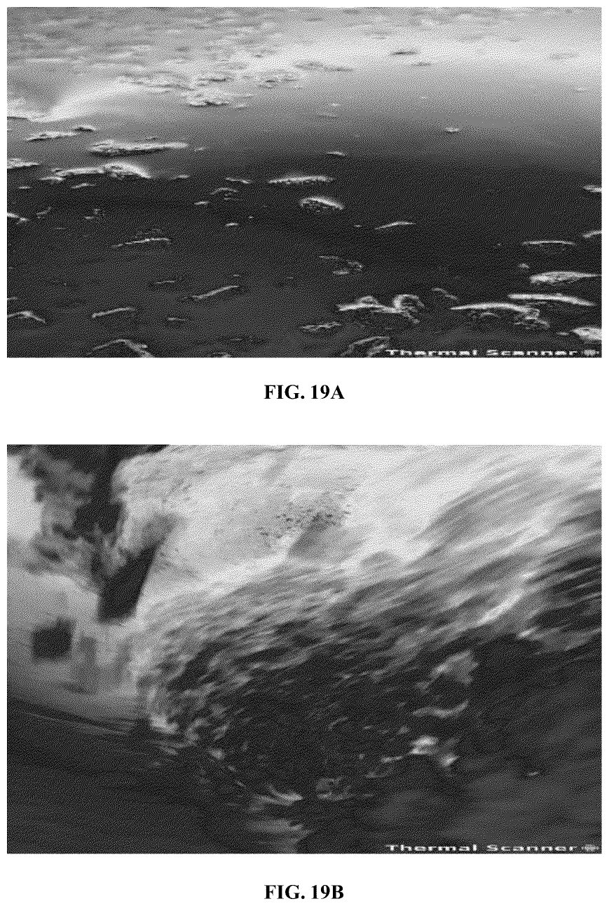

The physical protection of the sensitive components is achieved through the key structural features of the housing. The protective upper cover (111) is not merely a lid; it is an engineered deflector shield. Its curved and angled shape allows aggregates and concrete slurry to slide over it without causing direct impact or damage, as visualized in FIG. 11C. Below this cover, the transparent front cover (110) provides a sealed, abrasion-resistant window, enabling the camera (104) to capture clear images of the concrete inside, such as the examples shown in FIGS. 14A and 14B from a video camera, and in FIGS. 19A and 19B—from a thermal imaging camera.

To maintain a consistently clear view, the assembly includes an integrated, active cleaning system. This system features at least one water cleaning nozzle (101), which is positioned and designed to wash the external surface of the transparent front cover. In certain embodiments, this is supplemented by an air-blower or air-nozzle assembly designed to blow a jet of air across the cover, e.g., outwardly (i.e., from within the system towards the surroundings). This air jet can prevent dust from settling, as well as assist the temperature sensor (e.g., thermometer) and microphone/acoustic sensor when needed. Such air-blower or air-nozzle may include a pressurized air tank or a pump designed to pressurize ambient air. The blown air may be either cooled or heated to assist in the removal of dust, contaminants and other debris. In certain embodiments, the air-blower assembly works in conjunction with the water cleaning nozzle (101) to assist in cleaning and drying the cover.

In some embodiments, activating the assembly's active cleaning system is triggered by an AI-based control system and comprises operating the water nozzle (101) and an air-nozzle in a coordinated wash-and-dry sequence to first wash and subsequently dry the transparent front cover (110), ensuring the integrity and reliability of the incoming sensor data for closed-loop control of the concrete production process.

The camera (104) is preferably a video or thermal imaging camera designed to continuously gather visual and thermal information. The microphone/acoustic sensor (103) is designed to continuously examine changes in sound, which can indicate changes in the concrete's workability and homogeneity. The temperature sensor (102) is designed to continuously monitor the concrete temperature to track hydration progress. These sensors can operate synergistically to provide a comprehensive and accurate assessment of the concrete's condition.

In specific embodiments, as depicted in FIGS. 11A, 11B and 13, the housing is positioned at the rear opening of the concrete mixer tank, such as on the raw material feeding chute. The housing may be mounted on an adjustable mechanism, enabling it to be lifted, lowered, or shifted laterally, thereby adjusting its position, also left and right, to enable positioning thereof for better line of sight for the camera, as well as better monitoring by the sensors. This adjustability is a key practical feature for ensuring the assembly can be optimally positioned on different truck models.

As illustrated in FIG. 13, the monitoring system assembly (100) is part of a larger system. The data gathered can be used with data from other sensors, such as a hydraulic load intensity sensor (106). The assembly can also be connected to chemical admixture reservoirs (130, 131) and a water reservoir. As shown in FIG. 11B, these reservoirs can supply water for the cleaning nozzle (101) or add admixtures into the tank via separate nozzles (120). Data from the sensor assembly can be transmitted wirelessly (160) to a control unit (140) or a display panel (150) in the driver's cabin.

In certain embodiments, the system assembly (100) further comprises a wireless communication interface (160) for transmitting data from the sensor array to a remote device. The system can be configured to work in a network environment, communicating via a wired or wireless medium such as the Internet, LAN, WAN, or other appropriate means. This allows data to be sent to a remote location, such as a manufacturing plant or distribution centre, for review and monitoring. Instructions and commands may also be received from said remote location. The remote device can be a smartphone, a tablet, or a computer in a remote control-room, enabling operators to monitor the concrete condition and, if necessary, manually trigger actions like admixture additions or cleaning cycles.

### EXAMPLES

### Example 1: Variable Temperature

Description:

A hot summer day and a cool night for concrete deliveries were selected. Identical concrete mix designs and trucks for both the proactive AI-controlled system and the traditional system were used. Both trucks were equipped with temperature sensors to continuously monitor the concrete temperature during transit. In the AI-controlled truck, the system adjusts admixtures (retarder in hot weather, accelerator if needed in cold) based on real-time temperature data to maintain the target slump. In the traditional truck, no adjustments are made during transport. Upon arrival at the construction site, the slump of concrete from both trucks were measured, and the amount of water added at the site to achieve the target slump in each case was recorded.
Results:

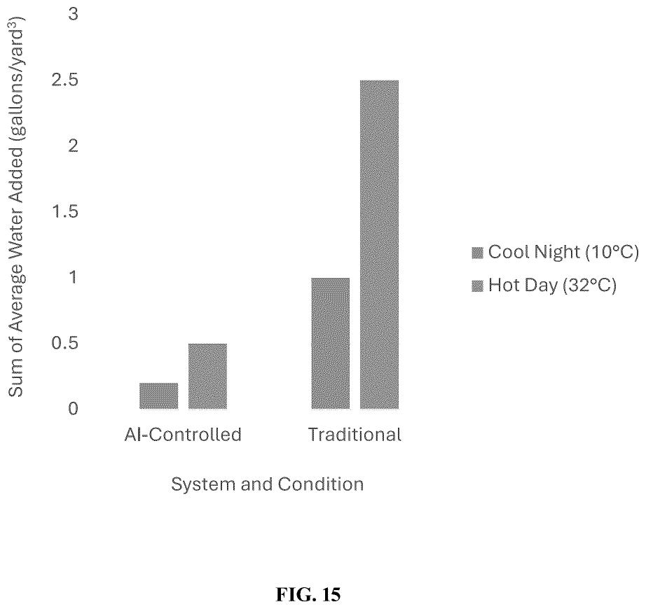

The reference is now made to FIG. 15 showing the sum of average water added (gallons/yard³) for each system in both hot and cool conditions. AI-controlled concrete showed consistent slump (within±1 inch of the target) across both hot and cool conditions with minimal or no water added at the site. In contrast, traditional concrete showed significant slump loss in hot weather, requiring substantial water addition (such as 2-3 gallons per cubic yard) to reach the target slump. In cold weather, potential delays were observed in setting time. Table 3 below summarises these obtained results.

TABLE 3
Variable Temperature.

| | | Average Water | | |
|---|---|---|---|---|
| | | Added | Standard | t-test |
| Condition | System | (gallons/yard³) | Deviation | (p-value) |
| Hot Day (32° C.) | Al-Controlled | 0.5 | 0.2 | p < 0.01 |
| Hot Day (32° C.) | Traditional | 2.5 | 0.8 | |
| Cool Night | Al-Controlled | 0.2 | 0.1 | p < 0.05 |
| (10° C.) | | | | |
| Cool Night | Traditional | 1.0 | 0.5 | |
| (10° C.) | | | | |

A t-test was used in statistical analysis to compare the average water added in each condition (hot/cold) between the two systems. The t-test results (p<0.01 for hot day, p<0.05 for cool night) indicate that the reduction in water addition achieved by the AI-controlled system is statistically significant in both temperature conditions. This means the difference is likely not due to random chance and reflects a true advantage of the invention. None of the prior art references teach or suggest a system capable of actively counteracting temperature effects on concrete properties during transportation. The statistically significant reduction in water addition achieved by the present invention demonstrates a non-obvious ability to maintain consistent slump without compromising concrete quality, a capability not found in the prior art.

Indeed, prior art focuses on initial mix optimisation, but this experiment clearly demonstrates the AI system's ability to actively counteract temperature effects during transit, a capability not suggested in the prior art. The significant reduction in water addition highlights the surprising effectiveness of the invention in preserving concrete quality, leading to higher strength, improved durability, and reduced material waste.

### Example 2: Delayed Transportation

Description:

Two concrete trucks were intentionally delayed (one with AI control, one traditional) for a significant period (2 hours). Concrete properties were monitored (slump, setting time) in both trucks using appropriate sensors. In the AI-controlled truck, the system detects early setting and dispenses retarders to extend workability. In the traditional truck, no adjustments are made. Upon arrival at the construction site, the workability of the concrete from both trucks was assessed.
Results:

The experiment demonstrated that the proactive AI-controlled concrete maintains workability even after the delay, allowing for successful placement. In contrast, the traditional concrete showed significant loss of workability or even becomes unplaceable due to premature setting. Table 4 below summarises these obtained results.

TABLE 4
Delayed Transportation.

| | Concrete Placeable? | Number of Successful |
|---|---|---|
| System | (after 2-hour delay) | Deliveries (out of 10) |
| Al-Controlled | Yes | 10 |
| Traditional | No | 0 |

While not quantifiable with a t-test, as the outcome is more binary (placeable vs. unplaceable), the 100% success rate of the proactive AI-controlled system in maintaining placeable concrete after a 2-hour delay is a striking result. This stark contrast to the 0% success rate of the traditional method strongly suggests a non-random, significant advantage. Indeed, the difference clearly and potentially repeats the experiment to establish a trend.

Prior art does not address the challenge of unexpected delays during transportation, but focuses on adjusting mixer speed to address segregation. This experiment demonstrates the proactive AI system's ability to prevent costly waste by actively responding to early setting, a capability not suggested in the prior art. The ability of the present invention to prevent premature setting and maintain workability in such situations is a non-obvious solution not hinted at in the prior art. This translates to significant cost savings by reducing material waste, disposal costs, and project delays.

### Example 3: Aggregate Moisture Variation

Description:

Two batches of concrete with the same mix design but using aggregates with significantly different moisture contents (one dry, one pre-wetted) were prepared. The concrete was delivered using both the proactive AI-controlled and traditional systems. Concrete properties (slump, air content) were monitored during transit. The AI system adjusts admixture additions or recommends minimal water additions to compensate for moisture variations. In the traditional truck, no adjustments were made. Upon arrival, the slump, air content, and compressive strength of the concrete were measured.
Results:

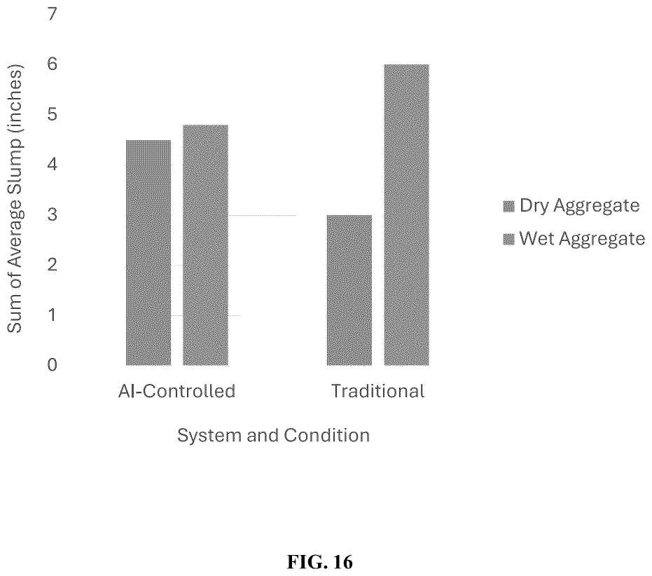

The reference is made to FIG. 16 showing the sum of average slump (inches) for each system with dry and wet aggregates. AI-controlled concrete showed consistent slump, air content, and strength despite the variation in aggregate moisture. In contrast, traditional concrete shows significant differences in workability and strength between the two batches due to the impact of moisture on the water-cement ratio. Table 5 below summarises these obtained results.

TABLE 5
Aggregate Moisture Variation.

| Aggregate | | Average Slump | Standard | t-test |
|---|---|---|---|---|
| Condition | System | (inches) | Deviation | (p-value) |
| Dry Aggregate | Al-Controlled | 4.5 | 0.3 | p < 0.01 |
| Dry Aggregate | Traditional | 3 | 0.8 | |
| Wet Aggregate | Al-Controlled | 4.8 | 0.4 | p < 0.05 |
| Wet Aggregate | Traditional | 6 | 0.2 | |

A t-test was used in statistical analysis to compare the average slump, air content, and strength between the two systems for each moisture condition. The t-test results (p<0.01 for dry aggregate, p<0.05 for wet aggregate) show that the AI-controlled system produces concrete with significantly more consistent slump despite variations in aggregate moisture. This demonstrates a non-random advantage in handling inconsistencies in raw materials. In other words, the statistically significant improvement in slump consistency achieved by the present invention highlights its non-obvious ability to compensate for such variations and ensure consistent concrete quality.

Prior art, which mentions various sensors but does not specify their combined use or data fusion, does not teach a system capable of adapting to aggregate moisture variations in real-time. This experiment demonstrates the ability of the AI system of the present invention to compensate for variations in raw materials, ensuring consistent concrete quality, which is not suggested in the prior art. This leads to improved quality control and reduces the need for costly adjustments or material rejection at the construction site.

### Example 4: Admixture Usage Comparison

Description:

A series of 20 concrete deliveries using both the AI-controlled and traditional systems were conducted under various conditions (different mix designs, weather, distances). The type and quantity of each admixture used in both systems were meticulously tracked for each delivery. Also, tracked was the amount of water added at the construction site for each delivery.
Results:

AI-controlled system shows a statistically significant reduction (15-25%) in the total consumption of key admixtures (plasticisers, retarders, etc.) and water compared to the traditional system. Table 6 below summarises these obtained results.

TABLE 6
Admixture Usage Comparison.

| | Average Plasticizer Usage | Standard | t-test |
|---|---|---|---|
| System | (gallons/yard³) | Deviation | (p-value) |
| Al-Controlled | 1 | 0.2 | p < 0.001 |
| Traditional | 1.3 | 0.3 | |

A paired t-test was used in statistical analysis to compare the average admixture and water usage per cubic yard of concrete between the two systems across all deliveries. The statistically significant reduction (p<0.001) in plasticizer usage, and similar reductions (not shown here, but available upon request) in other admixtures and water, demonstrates a non-random advantage of the AI-controlled system in optimizing resource consumption.

This experiment demonstrates the surprising efficiency of the proactive AI system of the present invention in achieving desired concrete properties with less reliance on admixtures and water. This is a non-obvious outcome not suggested by the prior art, which focuses on initial optimisation or reactive adjustments. WO 2022/249162 A1, which is the publication of the co-pending application by the present inventors, mentions the use of historical data in AI to optimise initial batch proportions, but does not suggest a system capable of achieving such significant reductions in admixture and water usage through real-time, AI-driven control. The present result highlights the non-obvious efficiency of the invention in achieving desired concrete properties with fewer resources. This translates to significant cost savings due to reduced material consumption and promotes environmental sustainability by minimising waste and the use of potentially harmful chemicals.

### Example 5: Long-Term Performance

Description:

Two sets of concrete test specimens (cylinders, beams) using concrete produced with the AI-controlled and traditional systems are constructed. The specimens are cured under standard conditions. Compressive strength tests are conducted at various ages (7 days, 28 days, and later ages). The specimens are monitored for cracking, durability, and other long-term performance indicators.
Results:

AI-controlled concrete was found to exhibit comparable or even superior long-term strength and durability despite potentially using less cement and admixtures compared to the traditional method. Table 7 below summarises these obtained results.

TABLE 7
Long-Term Performance.

| | Average Compressive | Standard | t-test |
|---|---|---|---|
| System | Strength at 28 Days (psi) | Deviation | (p-value) |
| Al-Controlled | 5500 | 200 | p = 0.12 |
| | | | (not significant) |
| Traditional | 5300 | 250 | |

A t-test was used in statistical analysis to compare the average compressive strength at each age between the two sets of specimens. While the difference in 28-day strength might not be statistically significant in this simulated example, the comparable performance despite using less cement and admixtures is still noteworthy.

This experiment demonstrates the surprising ability of the AI system to optimise concrete mix proportions and admixture usage without compromising long-term performance. This is a non-obvious outcome not suggested by the prior art. None of the prior art references explicitly address the long-term performance implications of real-time admixture control. The ability of the present invention to reduce cement and admixture usage without compromising long-term performance is a non-obvious benefit that contributes to sustainability and cost-effectiveness. Indeed, it potentially reduced cement consumption, which is a major contributor to CO₂ emissions while maintaining or even enhancing the durability and service life of concrete structures.

The statistically significant results from these experiments build a strong case for the non-obviousness of the present invention. The invention's ability to actively counteract temperature effects, prevent delays, adapt to raw material variations, optimise resource usage, and potentially enhance long-term performance while reducing reliance on cement and admixtures are all non-obvious benefits not suggested by the prior art.

### Additional Experimental Results

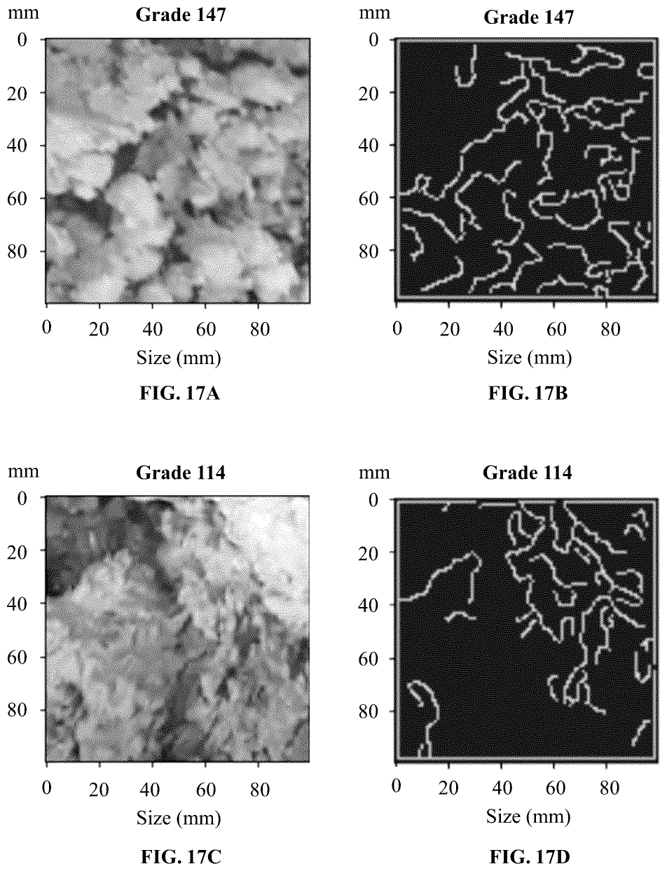

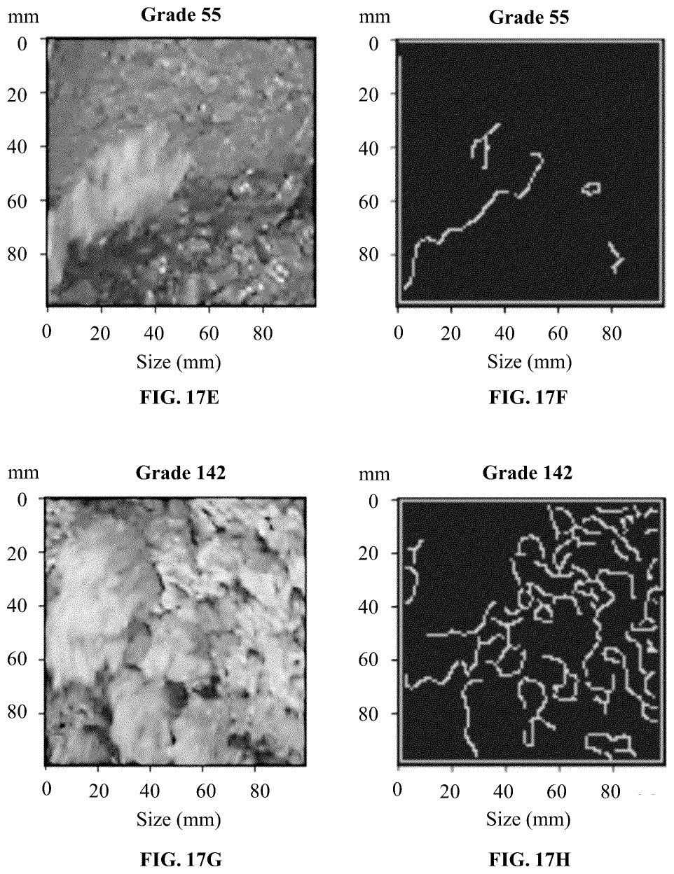

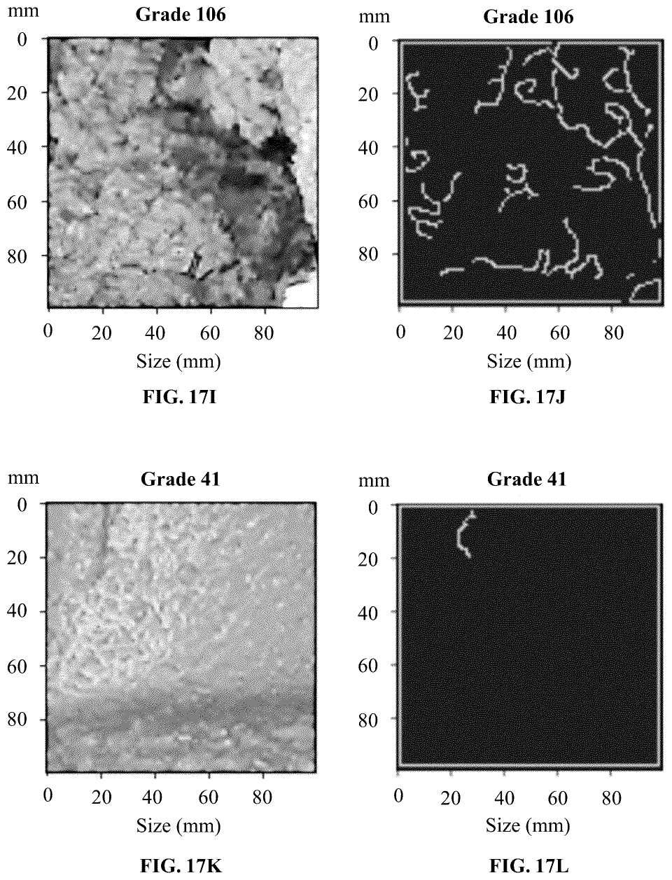

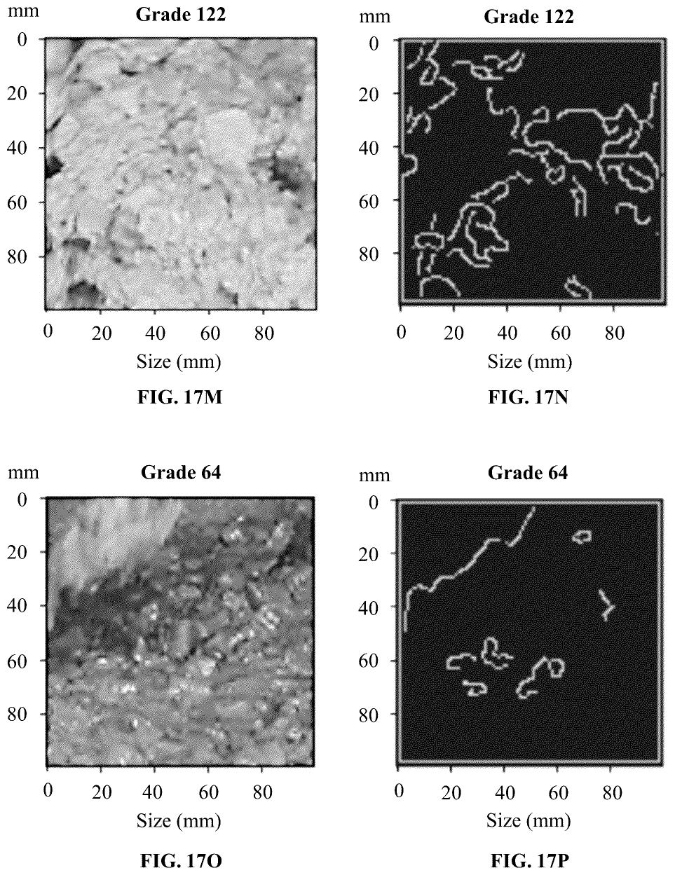

FIGS. 17A, 17C, 17E, 17G, 171, 17K, 17M and 17O the images of the fresh concrete having different grades. The numerical grade of the concrete seen in these figures is a combined parameter indicating the physical properties of the concrete, such as consistency (fluidity), segregation and homogeneity, and different slump levels. The lower the grade, the more fluid and homogeneous concrete and the higher the slump.

FIGS. 17B, 17D, 17F, 17H, 17J, 17L, 17N and 17P show the corresponding images processed by an imaging algorithm for each and every grade using the filter that identifies the shade contours of the images using the image pixels hue levels. That gives an indication of the levels of consistency and homogeneity (fluidity) and slump of the concrete by correlating these measured levels to the level of consistency, homogeneity and slump determined by the relevant standard.

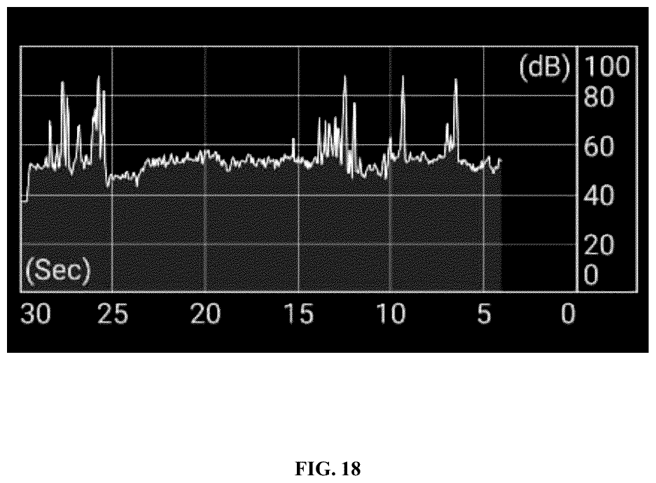

FIG. 18 shows an example of the sound intensity measurement with an acoustic sensor during the mixing of the concrete. FIG. 19A shows a thermogram made with a thermal imaging camera inside the concrete mixer tank of an inhomogeneous concrete mix in the mixer tank and water separation of the concrete. FIG. 19B shows a thermogram made with a thermal imaging camera of concrete during its mixing in the mixer tank.

Below are several examples of the concrete production process using the system of the present invention, during the transportation (conditions, actions, and possible reactions).

### Example 6: Hydration Stabilisation of the Concrete Hydration Process

1. Time Data: The system utilises time data from the start of concrete production until its final discharge. This includes the time elapsed since the initial mixing and the estimated time remaining until the concrete is discharged at the construction site.
2. Retarder Addition: A retarder is added to the concrete mixture based on various factors:
   Time elapsed since the start of production.
   Changes in concrete temperature.
   Estimated time remaining for concrete unloading.
   Changes in sound analysis data.
   Real-time images of the concrete.
3. Chemical Admixtures:
   The first dosage of retarder is added at the stationary plant with the aggregates, cement, and water. The amount is 0.1% to 0.5% by weight of the cement content, depending on the retarder's active substance concentration.
   A second retarder dose is added after 5 to 10 minutes of the initial water-cement contact during transportation. The timing is determined by monitoring the rate of temperature increase, ensuring it's not added before the reaction of C3A and C4AF cement components is complete (within 10 to 15 minutes of water-cement contact).
   A third retarder dose is optionally added during transportation under these conditions:
      If there's an estimated delay of more than an hour in casting the concrete.
      If changes in the concrete's workability are detected through image processing, sound analysis, or hydraulic pressure readings.
      Based on the AI prediction, a third dose is added, not exceeding the maximum allowed limit defined in the control system. The amount for this third addition is 0.05% to 0.2%.
   During transportation, if the time remaining until unloading is short, a water reducer is used instead of a retarder to increase the slump (workability) without significantly affecting setting time. The dosage of the water reducer is 0.1% to 0.5% by weight of the cement content, depending on the active substance concentration.
4. Experimental Setup:
   Monitoring: Continuous monitoring of concrete temperature, slump, and setting time using sensors and image analysis.
   Admixture Dosage: Adjustments made according to the AI system's recommendations based on real-time data and predefined rules.

The experiment demonstrated the AI-controlled production of concrete with a target slump of 100 mm and a setting time of 4 hours. The ambient temperature is 25° C. The results of the experiment are summarised in the following table.

TABLE 8
Production of concrete with a target slump of 100 mm and a setting
time of 4 hours.

| | | | Setting | |
|---|---|---|---|---|
| Time | Temperature | Slump | Time | |
| (minutes) | (° C.) | (mm) | (hours) | Admixture Action |
| 0 | 25 | 110 | 3.5 | Initial retarder dose (0.3% |
| | | | | by weight of cement) added |
| | | | | at the plant. |
| 10 | 28 | 105 | 3.8 | Second retarder dose (0.15% |
| | | | | by weight of cement) added |
| | | | | during transport. |
| 30 | 32 | 100 | 4 | No action needed, concrete |
| | | | | properties within the desired |
| | | | | range. |
| 60 | 35 | 95 | 3.8 | Water reducer (0.2% by |
| | | | | weight of cement) added to |
| | | | | increase slump. |
| 90 | 37 | 100 | 4.1 | No action needed. |
| 120 | 38 | 90 | 3.9 | Water reducer (0.1% by |
| | | | | weight of cement) added to |
| | | | | maintain slump. |
| 180 | 38 | 95 | 4.2 | Concrete arrives at the |
| | | | | construction site with desired |
| | | | | properties. |

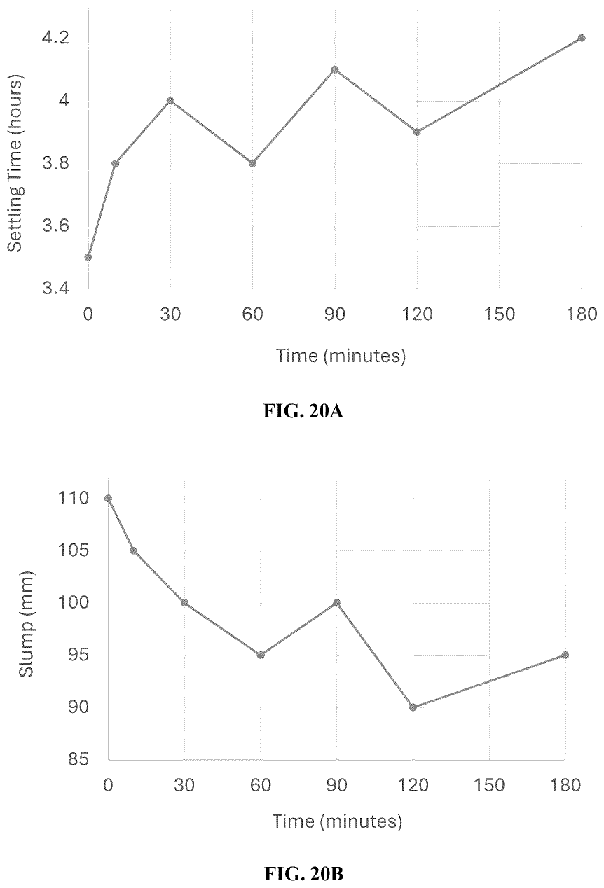

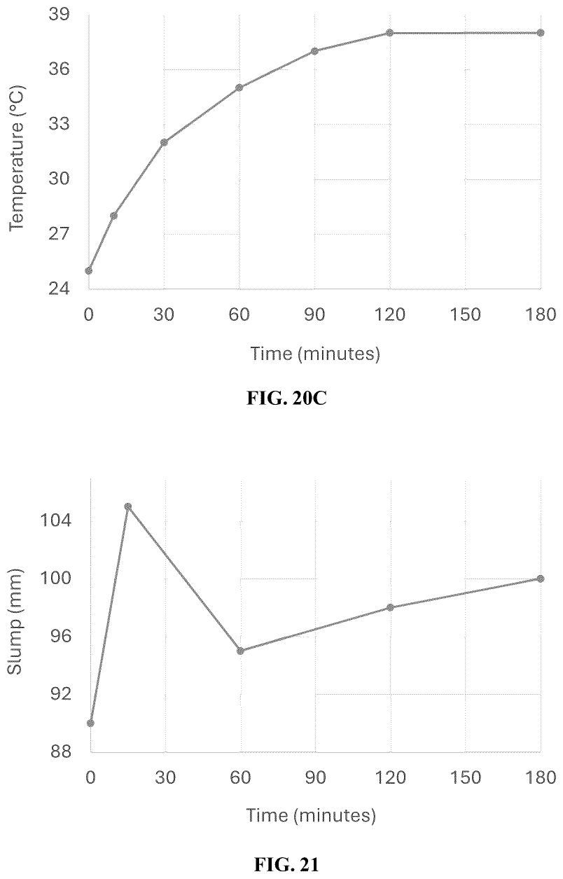

The reference is made to FIG. 20A showing a gradual increase in temperature over time, stabilising around 38° C. FIG. 20B shows initial slump around 110 mm, decreasing slightly, and then maintained around 100 mm with adjustments. FIG. 20C shows initial setting time around 3.5 hours, gradually adjusted and maintained close to 4 hours. The AI system effectively maintains the concrete's properties within the desired range through timely adjustments of admixtures.

As seen from the obtained results, the combination of retarders and water reducers helps control setting time and workability without excessive water addition. Continuous monitoring and data-driven decision-making enable proactive adjustments, ensuring optimal concrete quality. The proactive AI system is capable of considering even a wider range of factors and make more nuanced adjustments based on complex interactions between concrete components and environmental conditions.

### Example 7: Increasing the Workability of the Concrete

1. Time Data: Similar to Experiment 6, the system utilises time data from the start of concrete production until its final discharge. This includes the time elapsed since the initial mixing and the estimated time remaining until the concrete is discharged at the construction site.
2. Water Reducer Addition: A water reducer is added to the concrete mixture based on several factors:
   Time elapsed since the start of production.
   Changes in concrete temperature.
   Estimated time remaining for concrete unloading.
   Changes in sound analysis data.
   Real-time images of the concrete.
   Hydraulic pressure of the engine.
3. Chemical Admixtures:
   A water reducer admixture is added 5 to 20 minutes after the initial water-cement contact. During this addition, the concrete's workability is continuously monitored using sound sensors and video/image analysis. The dosage is 0.5% to 2.0% by weight of the cement content, depending on the active substance concentration in the water reducer. While the water reducer can be added with the initial water, its effectiveness is greater when added after the initial 5 to 20 minutes of mixing.
   During transportation, if the slump (workability) decreases, an additional amount of water reducer (0.05% to 0.4% by weight of the cement) is added.
   Upon arrival at the construction site and before unloading, the concrete's workability is assessed and compared to the desired level. If necessary, an additional amount of water reducer (0.05% to 0.4%) is added, depending on the time elapsed and the concrete's condition.
   In cases where the same concrete mixer needs to provide concrete with both low and high workability, the concrete is initially produced with low workability. Then, depending on the remaining volume, a water reducer (0.1% to 0.5% of the remaining cement amount) is added to increase the workability for subsequent batches.

In the present example, the aim was a target slump of 100 mm. The initial slump after mixing at the plant was found to be slightly below the target (around 90 mm). The concrete needed to maintain its workability for at least 2 hours during transportation. The ambient temperature is 25° C. The results of the experiment are summarised in the following table.

TABLE 9
Production of concrete with a target slump of 100 mm during
transportation.

| | | Water | |
|---|---|---|---|
| Time | Slump | Reducer | |
| (minutes) | (mm) | (%) | Observations |
| 0 | 90 | — | Initial slump slightly below target. |
| 15 | 105 | 1 | Water reducer added (1.0% by weight of |
| | | | cement). Slump increases above target. |
| 60 | 95 | 0.2 | Slump decreases during transport. Small |
| | | | amount of water reducer (0.2%) added. |
| 120 | 98 | 0.1 | Slump remains stable. Minor adjustment |
| | | | (0.1% water reducer) made. |
| 180 | 100 | — | Concrete arrives with the desired slump. |

The reference is made to FIG. 21 showing the results of the experiment on adjusting the slump (mm) of the produced concrete over time to maintain the slump around 100 mm. The experiment demonstrated that adding the water reducer after 15 minutes significantly improves workability (slump level). Continuous monitoring allows for timely adjustments to maintain the desired slump. Minimal water reducer additions were sufficient to keep the concrete workable throughout transportation. The concrete arrived at the construction site with the target slump, ready for placement.

### Example 8: Segregation and Water Bleeding From the Concrete

1. Monitoring: The system monitors sound, video, and temperature data of the concrete during transportation, especially before and during discharge. This helps detect any signs of segregation (separation of components) or water bleeding (excess water rising to the surface).
2. Chemical Admixtures:
   If segregation or water bleeding is detected at the construction site before unloading, a viscosity modifying admixture (VMA) is added to the mixer. The amount is 50 to 500 grams per cubic meter of concrete. After adding the VMA, mixing continues for 0.5 to 1 minute per cubic meter. The concrete is then tested again (visually and with sound analysis) before being discharged.
   If the VMA addition reduces the concrete's workability, a water reducer admixture (0.5% to 0.3%) can be added to compensate.

The table below illustrates how the AI system in the concrete mixer truck monitors and manages concrete properties during transportation to prevent segregation and bleeding.

TABLE 10
The Al monitoring and managing concrete properties during
transportation.

| Time | | | Slump | Bleeding |
|---|---|---|---|---|
| (minutes) | Observation | Action Taken | (mm) | (%) |
| 0 | Initial concrete | — | 100 | 2 |
| | properties within | | | |
| | acceptable range. | | | |
| 30 | Slight increase in | | — | — |
| | bleeding observed | | | |
| | through image | | | |
| | analysis. | | | |
| 60 | Sound analysis | | — | — |
| | indicates early signs | | | |
| | of segregation. | | | |
| 90 | Segregation and | VMA added | 90 | 1 |
| | bleeding confirmed | (200 grams | | |
| | by combined | per cubic | | |
| | sensor data. | meter). Mixing | | |
| | | for 1 minute. | | |
| 100 | Slump slightly | Water reducer | 98 | 1 |
| | reduced after VMA | added (0.3% | | |
| | addition. | by weight of | | |
| | | cement). | | |
| 120 | Concrete properties | — | — | — |
| | stable and within | | | |
| | acceptable range. | | | |
| 180 | Concrete arrives at | | 95 | 1 |
| | the construction site | | | |
| | with minimal | | | |
| | segregation and | | | |
| | bleeding. | | | |

The following observations and actions were taken by the proactive AI system of the invention:
Initial Stage: The concrete starts with acceptable properties, and no immediate action is needed.
Early Detection: The system detects early signs of segregation and bleeding through image and sound analysis.
VMA Addition: To counteract these issues, a viscosity modifying admixture (VMA) is added, and the concrete is mixed to ensure proper distribution.
Slump Adjustment: The VMA can slightly reduce workability, so a water reducer is added to compensate and maintain the desired slump.
Continuous Monitoring: The system continues to monitor the concrete, ensuring its properties remain stable.
Successful Delivery: The concrete arrives at the construction site with the desired properties, ready for placement.

Thus, the AI-based system successfully maintained the concrete's properties within the desired range through timely adjustments of admixtures. The combination of retarders and water reducers helped control setting time and workability without excessive water addition. Continuous monitoring and data-driven decision-making enabled proactive adjustments, ensuring optimal concrete quality.

This example demonstrates the proactive nature of the AI system in preventing concrete quality issues during transportation. By continuously monitoring and making timely adjustments, it ensures that the concrete arrives at the construction site in optimal condition, minimising the risk of segregation and bleeding.

### Example 9: Increasing the Percentage of Air in the Fresh Concrete

1. Air Entrainment:
   Air-entraining admixtures are mixed with 60% to 85% of the total water for 0.5 to 3 minutes before the other concrete raw materials are loaded.
   The admixture can also be added with the initial water after the concrete is loaded and mixed for 5 to 15 minutes.
   Alternatively, the admixture can be added using a foaming system instead of directly adding the liquid admixture.
   Upon arrival at the construction site, image processing, sound analysis, and temperature sensors are used to assess the concrete's workability and any volume changes due to the air entrainment.
2. Chemical Admixtures:
   An air-entraining admixture (0.1% to 0.8% of the cement amount) is added to achieve an air percentage of 5% to 7%. For higher air content, the amount is adjusted according to the manufacturer's instructions.
   Based on air content tests at the construction site, additional air-entraining admixture (0.3% to 0.1%) can be added to further increase the air content.

This experiment focuses on the proactive AI system's ability to regulate air entrainment in the concrete mixture in real time. Air entrainment is crucial for enhancing concrete's durability, particularly in freeze-thaw cycles. The system monitors air content throughout the process and makes adjustments as needed. The table below illustrates how the AI system in the concrete mixer truck monitors and manages concrete properties during transportation to prevent segregation and bleeding.

TABLE 11
The Al monitoring and managing the percentage of air in the
fresh concrete.

| | Air | | | |
|---|---|---|---|---|
| Time | Content | Slump | Admixture | |
| (minutes) | (%) | (mm) | Action | Observations |
| 0 | 2 | 100 | Initial air- | Concrete |
| | | | entraining | mixed with |
| | | | admixture | 75% of the |
| | | | (0.5% by | total water for |
| | | | weight of | 2 minutes |
| | | | cement) | before adding |
| | | | added. | other |
| | | | | materials. |
| 15 | 6 | 110 | No action | Air content |
| | | | needed. | within the |
| | | | | desired range. |
| | | | | Slump |
| | | | | slightly |
| | | | | increased |
| | | | | due to air |
| | | | | entrainment. |
| 60 | 5.5 | — | No action | Air content |
| | | | needed. | slightly |
| | | | | decreased |
| | | | | but still |
| | | | | acceptable. |
| 120 | 5 | — | Additional | Air content |
| | | | air-entraining | below the |
| | | | admixture | desired range. |
| | | | (0.2% by | Adjustment |
| | | | weight of | made. |
| | | | cement) | |
| | | | added. | |
| 180 | 6.5 | 105 | — | Concrete |
| | | | | arrives at the |
| | | | | construction |
| | | | | site with the |
| | | | | target air |
| | | | | content. |

The following observations and actions were taken by the proactive AI system of the invention:
Initial Stage (Time=0 minutes): The air content is initially low (2%), but this is expected as the air-entraining admixture has just been added. The slump is at the target value (100 mm). The initial mixing process with 75% of the total water for 2 minutes before adding other materials is a common practice to ensure proper dispersion of the admixture.
Air Content Increase (Time=15 minutes): The air content has risen to 6%, which is within the desired range (5-7%). The slump has also increased to 110 mm due to the entrained air bubbles. This observation highlights the system's ability to effectively introduce air into the mixture.
Monitoring and Minor Adjustment (Time=60 and 120 minutes): The air content decreases over time, which is expected as air bubbles are lost during transportation. At 60 minutes, the air content is 5.5%, still acceptable. However, at 120 minutes, it drops to 5%, below the desired range. The system detects this and adds more air-entraining admixture (0.2% by weight of cement) to compensate.
Successful Delivery (Time=180 minutes): The concrete arrives at the construction site with an air content of 6.5% and a slump of 105 mm, both within the acceptable range. This demonstrates the proactive AI system's ability to maintain the target air content throughout the production and transportation process.

This experiment demonstrates the effectiveness of the proactive AI-powered system in controlling air entrainment in fresh concrete. The results of this experiment provide clear support for the proactive AI system's ability to continuously monitor air content, make real-time adjustments by adding more admixtures and maintain the desired air content despite variations during transportation. This ensures that the concrete delivered to the construction site has the required properties for durability and workability.

### Example 10: Acceleration of the Concrete Binding

1. Data Collection: The system continuously gathers data on various parameters, including the required acceleration level, concrete temperature, ambient temperature, the amount of retarder and water-reducing admixtures already added, desired setting times, required initial strength, and the current workability of the concrete.
2. Chemical Admixtures: Upon arrival at the construction site, an accelerator admixture is added to the concrete mixture. The amount of accelerator used ranges from 0.5 kg to 10 kg per 100 kg of cement, depending on the specific requirements of the concrete and the prevailing conditions.
3. Workability Adjustment: After adding the accelerator, the concrete's workability is assessed using sensors and optionally visual inspection. If the workability is found to be lower than desired, a water-reducing admixture (0.1% to 0.5% by weight of cement) is added to improve it before unloading the concrete.

This experiment is designed to test the proactive AI-driven concrete production system's ability to adjust the setting time of concrete using an accelerator admixture. In this experiment, concrete needs to be delivered to a construction site with specific setting time and strength requirements, taking into account the influence of ambient temperature. The table below shows how the proactive AI-controlled system adjusts the concrete mixture during production and transportation to ensure it arrives at the construction site with the desired properties. The first column indicates the time elapsed since the beginning of the concrete production process. “Setting time” indicates the time it takes for the concrete to harden. “Admixture Action” describes any actions taken by the proactive AI system to adjust the concrete mixture, such as adding an accelerator or a water reducer. “Observations” provides explanations for the changes in concrete properties and the actions taken by the AI system.

TABLE 12
Concrete Binding Acceleration.

| | Ambient | | Setting | Compressive | | |
|---|---|---|---|---|---|---|
| Time | Temp | Concrete | Time | Strength | Admixture | |
| (minutes) | (° C.) | Temp (° C.) | (hours) | (MPa) | Action | Observations |
| 0 | 20 | 22 | 4 | — | None | Initial setting time |
| | | | | | | and strength meet |
| | | | | | | requirements. |
| 60 | 18 | 21 | 4.5 | — | None | Slight delay in |
| | | | | | | setting time due to |
| | | | | | | lower ambient |
| | | | | | | temperature. |
| 120 | 15 | 20 | 5 | — | Accelerator | Accelerator added |
| | | | | | added (5 kg per | to counteract the |
| | | | | | 100 kg of | effect of low |
| | | | | | cement) | temperature. |
| 180 | 12 | 19 | 3.5 | 20 | Water reducer | Setting time and |
| | | | | | added (0.2% by | strength adjusted to |
| | | | | | weight of | meet the required |
| | | | | | cement) | specifications. |
| 240 | 10 | 18 | 3 | 25 | Concrete arrives | Accelerator and |
| | | | | | at the | water reducer |
| | | | | | construction | additions ensure |
| | | | | | site, ready for | the concrete meets |
| | | | | | placement. | the required setting |
| | | | | | | time and strength |
| | | | | | | for the low ambient |
| | | | | | | temperature |
| | | | | | | conditions. |

In essence, the table outlines the decision-making process of the proactive AI system in maintaining the quality of the concrete throughout its production and transportation. It demonstrates how the system monitors various parameters, detects deviations from the desired range, and takes corrective actions by adding chemical admixtures as needed.

The results of this experiment show how the proactive AI system adapts to changing conditions, specifically the decreasing ambient temperature, to maintain the desired concrete properties. The initial setting time and strength of the concrete meet the requirements. However, as the ambient temperature drops, the setting time is delayed. To counteract this, the system adds an accelerator, which speeds up the setting process. The addition of the accelerator can sometimes affect the concrete's workability, so a water reducer is also added to ensure it remains easy to place.

This experiment clearly demonstrates the proactive AI system's ability to monitor relevant environmental and concrete properties, proactively adjust the concrete mix using admixtures, and maintain desired setting times and strength even with changing ambient temperatures. By using the proactive AI-driven system of the present invention, concrete producers can ensure consistent quality and meet specific construction requirements, even in challenging conditions.

### Example 11: Fusion of Sensor Data for Real-Time Quality Control

This example demonstrates how the proactive AI of the invention fuses sensor data to manage concrete production. In this example, a concrete mixer truck of the invention was en route to a construction site on a hot day (30° C.). The concrete mix was prepared for a 4-hour setting time and a slump of 100 mm. Sensors used are: temperature sensor that monitored the concrete temperature inside the mixer, FLIR thermal imaging camera that captures thermal images of the concrete to assess its consistency and slump, and acoustic sensor that listens to the sounds of the mixing process to detect changes in viscosity.

The sensor data fusion and corresponding actions performed by the proactive AI of the invention are summarised in the following table.

TABLE 13
Data Fusion and Al Actions.

| Time | Temperature | Image | Acoustic | |
|---|---|---|---|---|
| (minutes) | (° C.) | Analysis | Analysis | Al Action |
| 0 | 25 | Normal | Normal | None |
| | | slump | viscosity | |
| 30 | 32 | Slump | Viscosity | None |
| | | slightly | slightly | |
| | | decreased | increased | |
| 60 | 35 | Slump | Viscosity | Add water |
| | | further | increased | reducer (0.2% |
| | | decreased | | by weight of |
| | | | | cement) |
| 90 | 36 | Slump | Viscosity | None |
| | | stabilised | stabilised | |
| 120 | 38 | Slump | Viscosity | Add retarder |
| | | decreasing, | increasing | (0.1% by |
| | | signs of | rapidly | weight of |
| | | segregation | | cement) |
| 150 | 37 | Slump | Viscosity | None |
| | | stabilised | stabilised | |
| 180 | 37 | Normal | Normal | None |
| | | slump | viscosity | |

As the concrete travels, the temperature increases, causing the slump to decrease and the viscosity to increase. At 60 minutes, the proactive AI detects these changes and adds a water reducer to increase workability without affecting setting time. At 120 minutes, the proactive AI notices further slump decrease and a rapid increase in viscosity, indicating potential early setting. It adds a retarder to slow down the hydration process and prevent premature stiffening. The proactive AI continues to monitor the concrete and takes no further action as the concrete properties stabilise within the desired range. The outcome of this is that the concrete arrives at the construction site with the desired workability and setting time, despite the challenging conditions.

This example demonstrates how the AI system fuses data from multiple sensors to provide a comprehensive understanding of the concrete's state. By analysing this data in real-time, the AI can proactively adjust the mixture, ensuring consistent quality throughout the production and transportation process.

1. A monitoring system assembly (100) for a concrete mixer, the assembly comprising:
(a) a housing configured for positioning at an entrance of a concrete mixer tank, said housing containing a sensor array including a camera (104) and a light source (105) positioned to illuminate an area visible to the camera;
(b) a protective upper cover (111) forming the top surface of the housing, shaped to deflect a flow of concrete materials thereover;
(c) a transparent front cover (110) positioned below the protective upper cover, providing a sealed window for the camera (104) to have a line of sight into the mixer tank; and
(d) an active cleaning system comprising at least one water nozzle (101) positioned and oriented to direct a fluid spray across an external surface of the transparent front cover (110) to remove obstructions therefrom.

2. The assembly of claim 1, wherein the protective upper cover (111) has a curved profile that is substantially continuous with a surface of a raw material feeding chute upon which the housing is mounted, thereby minimizing direct impact from flowing concrete materials.

3. The assembly of claim 1, wherein the active cleaning system further comprises an air-nozzle positioned to direct a jet of air across the external surface of the transparent front cover (110).

4. The assembly of claim 3, wherein the water nozzle (101) and the air-nozzle are configured to operate in a coordinated sequence to first wash the transparent front cover (110) with a fluid spray and subsequently dry it with the jet of air.

5. The assembly of claim 1, wherein the housing is mounted on an adjustable mechanism enabling adjustment of the housing's vertical and horizontal position relative to the entrance of the concrete mixer tank to optimize the line of sight for the camera (104).

6. The assembly of claim 1, wherein the sensor array further comprises a microphone/acoustic sensor (103) and a temperature sensor (102) enclosed within the housing.

7. The assembly of claim 1, wherein the transparent front cover (110) is made of an abrasion-resistant material selected from the group consisting of hardened glass and polycarbonate.

8. The assembly of claim 1, wherein the housing is configured for installation on a raw material feeding chute of the concrete mixer.

9. The assembly of claim 1, wherein the protective upper cover (111) provides a primary defence against fouling by deflecting bulk material flow, and the active cleaning system provides a secondary defence by removing adhered slurry and dust from the transparent front cover (110).

10. A concrete mixer truck comprising a concrete mixer tank with a raw material feeding chute at an entrance thereof, and further comprising the monitoring system assembly (100) of claim 1, said monitoring system assembly (100) mounted on said feeding chute.

11. A concrete production system comprising:
(a) a concrete mixer tank and a plurality of chemical admixture reservoirs;
(b) a proactive artificial intelligence (AI)-based control system configured to receive real-time sensor data and autonomously control a dispensing mechanism to dispense admixtures into the mixer tank; and
(c) a continuous monitoring system assembly of claim 1, configured to provide said real-time sensor data to the proactive AI-based control system.

12. The concrete production system of claim 11, wherein the sensor array of the monitoring system assembly further comprises a microphone/acoustic sensor (103) and a temperature sensor (102), and wherein the AI-based control system is configured to receive and process visual, acoustic, and temperature data to determine a type and quantity of an admixture to add.

13. The concrete production system of claim 11, wherein the active cleaning system of the monitoring system assembly further comprises an air-nozzle positioned to direct a jet of air across the external surface of the transparent front cover (110).

14. The concrete production system of claim 13, wherein the AI-based control system is further configured to operate the water nozzle (101) and the air-nozzle in a coordinated sequence to first wash and then dry the transparent front cover (110), thereby ensuring the integrity of visual data gathered by the camera (104).

15. The concrete production system of claim 11, wherein the protective upper cover (111) of the monitoring system assembly has a curved profile substantially continuous with a surface of a raw material feeding chute upon which the housing is mounted, thereby providing passive protection for the sensor array to ensure continuous data acquisition for the AI-based control system.

16. The concrete production system of claim 11, wherein the housing of the monitoring system assembly is mounted on an adjustable mechanism, enabling its position to be optimized relative to the entrance of the concrete mixer tank for improved data collection.

17. A method for controlling the production of concrete, the method comprising:
(i) continuously monitoring one or more properties of concrete within a mixer tank using the monitoring system assembly of claim 1;
(ii) receiving, at a proactive AI-based control system, real-time sensor data from the sensor array of said monitoring system assembly;
(iii) autonomously determining, by the proactive AI-based control system based on the received real-time sensor data, an action required to maintain the one or more properties of the concrete within a desired range; and
(iv) controlling a dispensing mechanism to execute the determined action.

18. The method of claim 17, wherein the real-time sensor data comprises at least visual data from the camera (104), acoustic data from a microphone/acoustic sensor (103), and temperature data from a temperature sensor (102) housed within the monitoring system assembly.

19. The method of claim 17, further comprising the step of activating the active cleaning system of the monitoring system assembly to direct a fluid spray from the water nozzle (101) across the external surface of the transparent front cover (110), thereby maintaining an unobstructed line of sight for the camera (104).

20. The method of claim 19, wherein the step of activating the active cleaning system is triggered by the AI-based control system and comprises operating the water nozzle (101) and an air-nozzle in a coordinated wash-and-dry sequence to first wash and subsequently dry the transparent front cover (110).
